(19) United States
(12) Patent Application Publication
(10) Pub. No.: US 2019/0077419 A1
(43) Pub. Date: Mar. 14, 2019

(54) AUTONOMOUS DRIVING CONTROL APPARATUS, DRIVING INFORMATION OUTPUT APPARATUS, AUTONOMOUS DRIVING CONTROL METHOD, AND DRIVING INFORMATION OUTPUT METHOD

(71) Applicants: DENSO CORPORATION, Kariya-city, Aichi-pref. (JP); SOKEN, INC., Nisshin-city, Aichi-pref (JP)

(72) Inventors: Norio SAMMA, Nishio-city, Aichi-pref. (JP); Sei IGUCHI, Kariya-city, Aichi-pref. (JP); Hirotaka GOTO, Kariya-city, Aichi-pref. (JP); Yukihiro KATO, Kariya-city, Aichi-pref. (JP)

(21) Appl. No.: 16/084,386

(22) PCT Filed: Jan. 27, 2017
(86) PCT No.: PCT/JP2017/002848

§ 371 Date: Sep. 12, 2018

(30) Foreign Application Priority Data
Mar. 14, 2016 (JP) 2016-49864

(51) Int. Cl. B60W 50/16; B60W 30/095; G05D 1/00; B60N 2/90

(52) U.S. Cl. CPC B60W 50/16; B60W 30/0956; G05D 2201/0213; B60N 2/90; B60N 2002/981; G05D 1/0088

(57) ABSTRACT

An autonomous driving control apparatus that controls the driving operation of a vehicle on the basis of the surrounding situation of the vehicle and achieves autonomous driving is provided. The autonomous driving control apparatus is provided with: a driving operation decision portion that determines a content of the driving operation of the vehicle on the basis of the surrounding situation of the vehicle; a driving operation control portion that controls the driving operation of the vehicle according to the decided content of the driving operation; and a driving information output portion that drives a driving portion provided on a seat of the vehicle to output the decided content of the driving operation as driving information.

### CROSS REFERENCE TO RELATED APPLICATION

This application is based on Japanese Patent Application No. 2016-49864 filed on Mar. 14, 2016, the disclosure of which is incorporated herein by reference.

### TECHNICAL FIELD

The present disclosure relates to a technique for autonomously driving a vehicle based on a surrounding situation of the vehicle.

### BACKGROUND ART

Nowadays, techniques are being developed to achieve autonomous driving of a vehicle by maintaining a lane on which the vehicle is traveling and avoiding an obstacle while grasping the surrounding situation of the vehicle. During autonomous driving, a computer (hereinafter referred to as a driving control apparatus) mounted in the vehicle drives the vehicle instead of a driver, so that the driver often has a feeling of discomfort with the way of driving by the driving control apparatus (for example, a lane taken at the time of curve traveling or avoiding an obstacle, the timing or the degree of an acceleration or deceleration, or the like).

Therefore, a technique has been proposed to bring the way of driving by the driving control apparatus as close as possible to the way of driving by a standard driver (for example, Patent Literature 1).

### PRIOR ART LITERATURE

### Patent Literature

Patent Literature 1: JP 2014-218098 A

### SUMMARY OF INVENTION

However, the proposed technique cannot sufficiently reduce the feeling of discomfort provided to a vehicle occupant during the autonomous driving, which has been a problem. This is because the way of driving varies depending also on the surrounding situation or the personality of the driver, and there are thus limits in the attempt to bring the way of driving by the driving control apparatus close to the way of driving that the occupant of the vehicle feels natural.

It is an object of the present disclosure to provide a technique capable of autonomously driving a vehicle without providing a feeling of discomfort to an occupant of a vehicle.

According to one aspect of the present disclosure, an autonomous driving control apparatus, a driving information output apparatus, an autonomous driving control method, and a driving information output method causes a driving portion provided in the seat of the vehicle is driven to output the decided content of the driving operation as driving information, when a content of driving operation of a vehicle is decided based on the surrounding situation of the vehicle.

With this, it may be possible for the occupant of the vehicle to recognize in advance the content of the autonomous driving operation. Thus, even when the way of driving during the autonomous driving is different from the way of driving that the occupant feels natural, it may be possible to autonomously drive the vehicle without providing a feeling of discomfort to the occupant.

### BRIEF DESCRIPTION OF DRAWINGS

The above and other objects, features and advantages of the present disclosure will become more apparent from the following detailed description made with reference to the accompanying drawings. In the drawings:

FIG. 1 is an explanatory view of a host vehicle mounted with an autonomous driving control apparatus of the present embodiment;

FIG. 2 is a block diagram showing an internal configuration of the autonomous driving control apparatus of the present embodiment;

FIG. 3A is an explanatory view illustrating how to give notice of acceleration/deceleration of the host vehicle by inclining a backrest portion of a seat;

FIG. 3B is an explanatory view showing positive and negative of an inclination angle of the backrest portion of the seat;

FIG. 4A is an explanatory view illustrating how to give notice of rightward steering or leftward steering of the host vehicle by inclining a lumbar support portion of the seat;

FIG. 4B is an explanatory view showing positive and negative of an inclination angle of the lumbar support portion of the seat;

FIG. 5 is a flowchart of a first half of an autonomous driving control process executed by the autonomous driving control apparatus of the present embodiment;

FIG. 6 is a flowchart of a second half of the autonomous driving control process;

FIG. 7A is an explanatory view illustrating how the autonomous driving control apparatus of the present embodiment decides timing for giving notice of the content of autonomous driving operation and start timing of the autonomous driving operation based on collision time;

FIG. 7B is an explanatory view illustrating how the autonomous driving control apparatus of the present embodiment decides to start the autonomous driving operation;

FIG. 7C is an explanatory view illustrating how the autonomous driving control apparatus of the present embodiment decides to give notice of the content of the autonomous driving operation;

FIG. 8A is an explanatory view showing an example in which the autonomous driving control apparatus of the present embodiment gives notice of the content of the autonomous driving operation and the start timing of the autonomous driving operation based on the distance to the object on the map;

FIG. 8B is an explanatory view showing another example in which the autonomous driving control apparatus of the present embodiment gives notice of the content of the autonomous driving operation and the start timing of the autonomous driving operation based on the distance to the object on the map;

FIG. 9 is an explanatory diagram illustrating how to give notice of the content of the autonomous driving operation by changing an angle θB of the backrest portion of the seat in accordance with an acceleration rate of a host vehicle 1;

FIG. 10 is an explanatory diagram illustrating how to give notice of the content of the autonomous driving operation by changing an angle ϕL of the lumbar support portion of the seat in accordance with a steering amount;

FIG. 11A is an explanatory diagram illustrating another mode of giving notice of the content of the autonomous driving operation by changing the angle θB of the backrest portion or the angleϕL of the lumbar support portion of the seat;

FIG. 11B is an explanatory diagram illustrating another mode of giving notice of the content of the autonomous driving operation by changing the angle θB of the backrest portion or the angle ϕL of the lumbar support portion of the seat;

FIG. 11C is an explanatory diagram illustrating another mode of giving notice of the content of the autonomous driving operation by changing the angle θB of the backrest portion or the angle ϕL of the lumbar support portion of the seat;

FIG. 12A is an explanatory diagram illustrating another mode of giving notice of the content of the autonomous driving operation by vibrating the angle θB of the backrest portion or the angle ϕL of the lumbar support portion of the seat;

FIG. 12B is an explanatory diagram illustrating another mode of giving notice of the content of the autonomous driving operation by vibrating the angle ϕB of the backrest portion or the angle ϕL of the lumbar support portion of the seat;

FIG. 12C is an explanatory diagram illustrating another mode of giving notice of the content of the autonomous driving operation by vibrating the angle θB of the backrest portion or the angle ϕL of the lumbar support portion of the seat;

FIG. 13 is an explanatory diagram illustrating how to give notice of the content of the autonomous driving operation by changing the angle θB of the backrest portion of the seat in accordance with the target vehicle speed of the host vehicle;

FIG. 14 is an explanatory diagram illustrating how to give notice of the content of steering by autonomous driving by changing the angle ϕL of the lumbar support portion of the seat;

FIG. 15A is an explanatory view illustrating the time of non-steering in another mode of giving notice of the content of steering by autonomous driving by inclining the lumbar support portion of the seat;

FIG. 15B is an explanatory view illustrating the time of rightward steering in another mode of giving notice of the content of steering by autonomous driving by inclining the lumbar support portion of the seat;

FIG. 15C is an explanatory view illustrating the time of leftward steering in another mode of giving notice of the content of steering by autonomous driving by inclining the lumbar support portion of the seat;

FIG. 16A is an explanatory view illustrating another mode of giving notice of the content of the autonomous driving operation by sliding the seat;

FIG. 16B is an explanatory view illustrating another mode of giving notice of the content of the autonomous driving operation by sliding the seat;

FIG. 17 is an explanatory view illustrating another mode of giving notice of the content of the autonomous driving operation by inclining the seat;

FIG. 18A is an explanatory view illustrating another mode of giving notice of the content of the autonomous driving operation by moving the headrest of the seat;

FIG. 18B is an explanatory view illustrating another mode for giving notice of the content of the autonomous driving operation by moving the headrest of the seat;

FIG. 19A is an explanatory view illustrating the mode of giving notice of the content of the autonomous driving operation by moving a moving floor surface mounted in front of the seat;

FIG. 19B is an explanatory view illustrating the mode of giving notice of the content of the autonomous driving operation by moving the moving floor surface mounted in front of a seat;

FIG. 20A is an explanatory view illustrating another mode of giving notice of the content of the autonomous driving operation by moving the moving floor surface mounted in front of the seat;

FIG. 20B is an explanatory view illustrating another mode of giving notice of the content of the autonomous driving operation by moving the moving floor surface mounted in front of the seat;

FIG. 21A is an explanatory view illustrating the mode of giving notice of the content of an autonomous driving operation by moving an armrest mounted lateral to the seat;

FIG. 21B is an explanatory view illustrating the mode of giving notice of the content of the autonomous driving operation by moving the armrest mounted lateral to the seat;

FIG. 22A is an explanatory view illustrating another mode of giving notice of the content of the autonomous driving operation by moving an armrest mounted lateral to a seat;

FIG. 22B is an explanatory view illustrating another mode of giving notice of the content of the autonomous driving operation by moving the armrest mounted lateral to the seat; and

FIG. 23 is an explanatory diagram of operation to request override to the driver by vibrating the backrest portion or the lumbar support portion during the autonomous driving.

### DESCRIPTION OF EMBODIMENTS

Hereinafter, an embodiment will be described.

### A. Apparatus Configuration

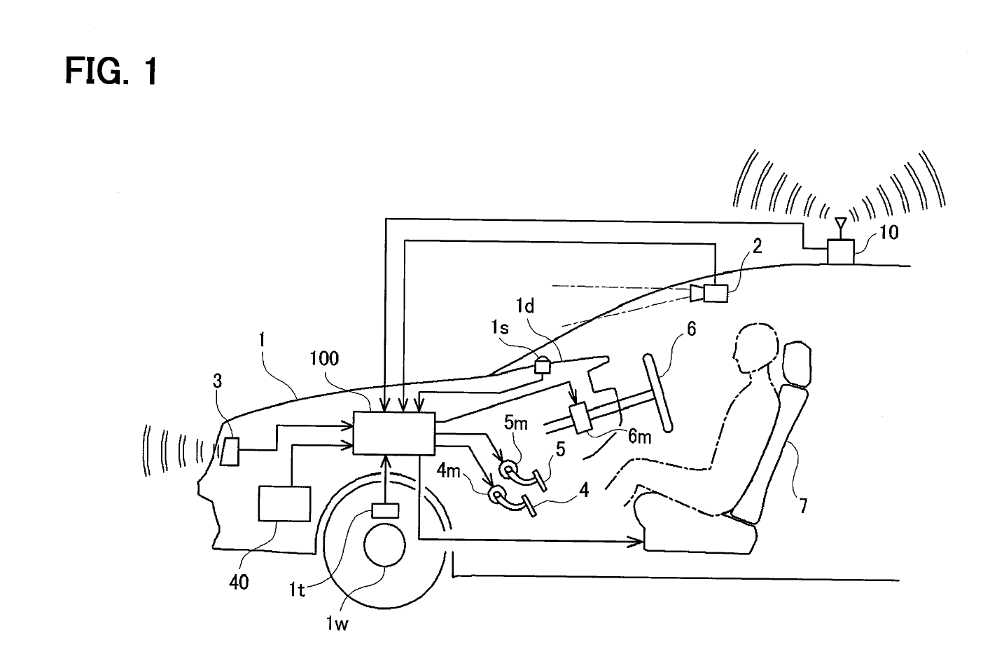

FIG. 1 shows a configuration of a host vehicle 1 mounted with an autonomous driving control apparatus 100 of the present embodiment. The host vehicle 1 of the present embodiment is provided with an in-vehicle camera 2 for capturing an image in a traveling direction, a radar 3 for detecting other vehicles and obstacles existing in front of the host vehicle, a vehicle speed sensor 1t for detecting a vehicle speed based on rotation of wheels 1w, a sunshine sensor 1s mounted on a dashboard 1d of the host vehicle 1 for detecting an amount of sunshine from the sun, a wireless communication device 10 communicating with the outside wirelessly, a navigation system (hereinafter, a navigation system 40) for showing a route to a preset destination, an accelerator pedal actuator 4m for driving an accelerator pedal 4, a brake pedal actuator 5m for driving a brake pedal 5, a steering wheel actuator 6m for driving a steering wheel 6 or the like.

The navigation system generally includes a function of detecting the position of the host vehicle 1, a function of storing map information, a function of setting a destination, a function of searching a route to the destination, and a function of presenting the searched route and guiding the route. However, the autonomous driving control apparatus 100 of the present embodiment may only detect the position of the host vehicle 1 by using the navigation system 40, and grasp the situation in front of the host vehicle 1 by using the map information stored in the navigation system 40. The autonomous driving control apparatus 100 may not be necessarily mounted with the function of searching a route to the set destination and the function of presenting the searched route. Therefore, the navigation system 40 of the present embodiment can also be a system in which the function of setting a destination, the function of searching a route to the destination, and the function of presenting the searched route are omitted from a general navigation system.

The autonomous driving control apparatus 100 detects the surrounding situation of the host vehicle 1 based on a captured image obtained by the in-vehicle camera 2 and an output of the radar 3, and drives the accelerator pedal actuator 4m, the brake pedal actuator 5m, and the steering wheel actuator 6m in accordance with the route shown by the navigation system 40, to execute autonomous driving. In the present embodiment, for the purpose of avoiding complicated description, a description is given assuming that the autonomous driving control apparatus 100 exclusively detects the surrounding situation by using the image captured by the in-vehicle camera 2, or using the output of the radar 3, but the autonomous driving control apparatus 100 may detect the surrounding situation by using a sonar (not shown) or the like.

As described later, multiple actuators for moving the backrest and the lumbar support are built in a seat 7 on the driver's seat side provided with the steering wheel 6. The autonomous driving control apparatus 100 can control the movement of these actuators.

In the present embodiment, the seat 7 is described as a seat on the driver's seat side. However, the seat 7 may be a seat other than the driver's seat (that is, a passenger seat or a back seat).

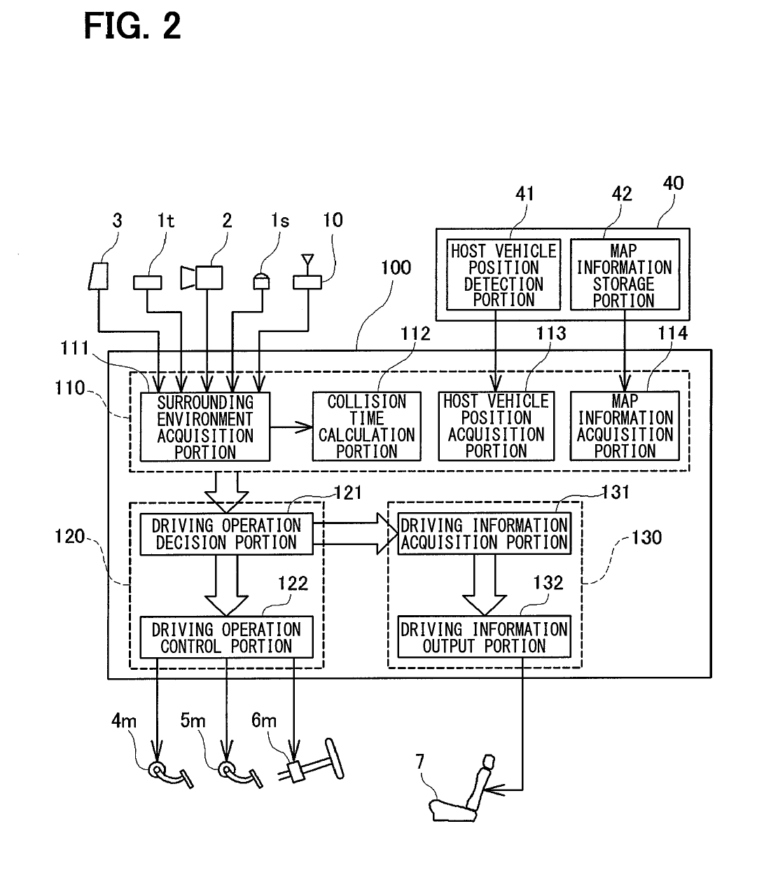

FIG. 2 shows a rough internal configuration of the autonomous driving control apparatus 100 of the present embodiment. As shown in the drawing, the autonomous driving control apparatus 100 mainly includes three modules, that is, a traveling environment acquisition module 110 for acquiring various types of information on the traveling environment of the host vehicle 1, an autonomous driving execution module 120 for executing autonomous driving, and a driving operation notice module 130 for giving notice of a content of autonomous driving operation to the driver. The autonomous driving execution module 120 corresponds to an “autonomous driving control portion”. The driving operation notice module 130 corresponds to a “driving information output apparatus”.

The traveling environment acquisition module 110 is provided with a surrounding environment acquisition portion 111, a collision time calculation portion 112, a host vehicle position acquisition portion 113, and a map information acquisition portion 114. Further, the autonomous driving execution module 120 is provided with a driving operation decision portion 121 and a driving operation control portion 122. The driving operation notice module 130 is provided with a driving information acquisition portion 131 and a driving information output portion 132.

These “modules” or “portions” are abstract concepts obtained by paying attention to functions provided to the autonomous driving control apparatus 100 to give notice of the content of the driving operation during the autonomous driving to the driver and classifying the inside of the autonomous driving control apparatus 100 for convenience. Therefore, this does not mean that the autonomous driving control apparatus 100 is physically divided into these “modules” or “portions”. These “modules” or “portions” can be realized as a computer program executed by a CPU, can be realized as an electronic circuit including an LSI and a memory, and can furthermore be realized by combining these.

The surrounding environment acquisition portion 111 of the traveling environment acquisition module 110 is connected to the in-vehicle camera 2, the radar 3, the vehicle speed sensor 1t, the sunshine sensor 1s, and the wireless communication device 10. Among these, a captured image is acquired from the in-vehicle camera 2. And the acquired captured image is analyzed, to detect other vehicles, obstacles, pedestrians and the like existing in front of the host vehicle 1. From the radar 3, the presence or absence of other vehicles, obstacles, pedestrians or the like existing in front, and the distance from the host vehicle 1 are detected. The speed of the host vehicle 1 is acquired from the vehicle speed sensor 1t. The intensity of sunlight (that is, the amount of sunshine) is acquired from the sunshine sensor 1s. Further, the surrounding environment acquisition portion 111 communicates with other vehicles, traffic lights, roadside devices or the like existing in the surroundings by using the wireless communication device 10. The surrounding environment acquisition portion 111 can thus acquire information such as the vehicle speed of other vehicles, information on the display of traffic lights, information on traffic conditions or the like.

The collision time calculation portion 112 calculates collision time for other vehicles, pedestrians, obstacles or the like existing in front of the host vehicle 1. The collision time is an estimated time until colliding with each of other vehicles, pedestrians, obstacles or the like existing in front (hereinafter referred to as “forward object”) when the current vehicle speed is continued. The collision time can be obtained by dividing the distance from the host vehicle 1 to the forward object by the relative speed between the host vehicle 1 and the forward object.

As described above, the surrounding environment acquisition portion 111 can detect the presence or absence of the forward object and the distance to the forward object based on the captured image from the in-vehicle camera 2 and the output of the radar 3. Thus, when the surrounding environment acquisition portion 111 detects the forward object, the collision time calculation portion 112 acquires the distance to the forward object. Further, every time a certain period of time elapses, by acquiring the distance to the forward object, the relative speed between the forward object and the host vehicle 1 is calculated. The distance to the forward object is divided by the relative speed thus obtained, to calculate the collision time for the forward object.

When the forward object is another vehicle, a difference is obtained between the vehicle speed of another vehicle acquired by performing inter-vehicle communication using the wireless communication device 10 and the vehicle speed of the host vehicle 1 obtained from the vehicle speed sensor 1t, so that the relative speed can be calculated.

The host vehicle position acquisition portion 113 acquires the current position of the host vehicle 1 from a host vehicle position detection portion 41 built in the navigation system 40. The host vehicle position detection portion 41 can receive a signal from a positioning satellite to detect the current position of the host vehicle 1.

The map information acquisition portion 114 acquires map information of a peripheral area including the current position of the host vehicle 1 from a map information storage portion 42 built in the navigation system 40.

When the current position of the host vehicle 1 and the map information of the peripheral area of the host vehicle 1 are known, it is possible to know distances to a curve, an intersection or the like existing in front of the host vehicle 1. Thus, the collision time calculation portion 112 may acquire these pieces of information so as to calculate the collision time for a curve, an intersection or the like existing in front.

The driving operation decision portion 121 of the autonomous driving execution module 120 acquires various types of information described above from the surrounding environment acquisition portion 111, the collision time calculation portion 112, the host vehicle position acquisition portion 113, and the map information acquisition portion 114 of the traveling environment acquisition module 110, to decide the driving operation of the host vehicle 1. Here, the driving operation of the host vehicle 1 is a concept including the operation amount of the driving operation in addition to the types of driving operation such as acceleration, deceleration, and rightward and leftward steering of the host vehicle 1. Further, an operation amount 0 of acceleration or deceleration represents the driving operation of maintaining the current speed, and an operation amount 0 of the rightward steering or the leftward steering represents the driving operation of traveling straight.

After deciding the type of driving operation and the operation amount, it is possible to predict the behavior of the host vehicle 1 afterward (for example, the vehicle speed, the acceleration rate, the acceleration rate in the lateral direction, and the speed component in the lateral direction). Thus, when the driving operation of the host vehicle 1 is to be decided, the operation including these behaviors may be decided as the driving operation.

The driving operation control portion 122 controls the accelerator pedal actuator 4m, the brake pedal actuator 5m, and the steering wheel actuator 6m in accordance with the driving operation decided by the driving operation decision portion 121.

Before outputting the decided driving operation to the driving operation control portion 122, the driving operation decision portion 121 outputs driving information on the content of the driving operation to the driving information acquisition portion 131 of the driving operation notice module 130. Then, the driving information acquisition portion 131 outputs the received driving information to the driving information output portion 132. Then, the driving information output portion 132 drives an actuator, described later, built in the seat 7 to move the backrest and the lumbar support of the seat 7, so as to present driving information to the occupant (the driver during non-autonomous driving) sitting on the seat 7 on the driver's seat side.

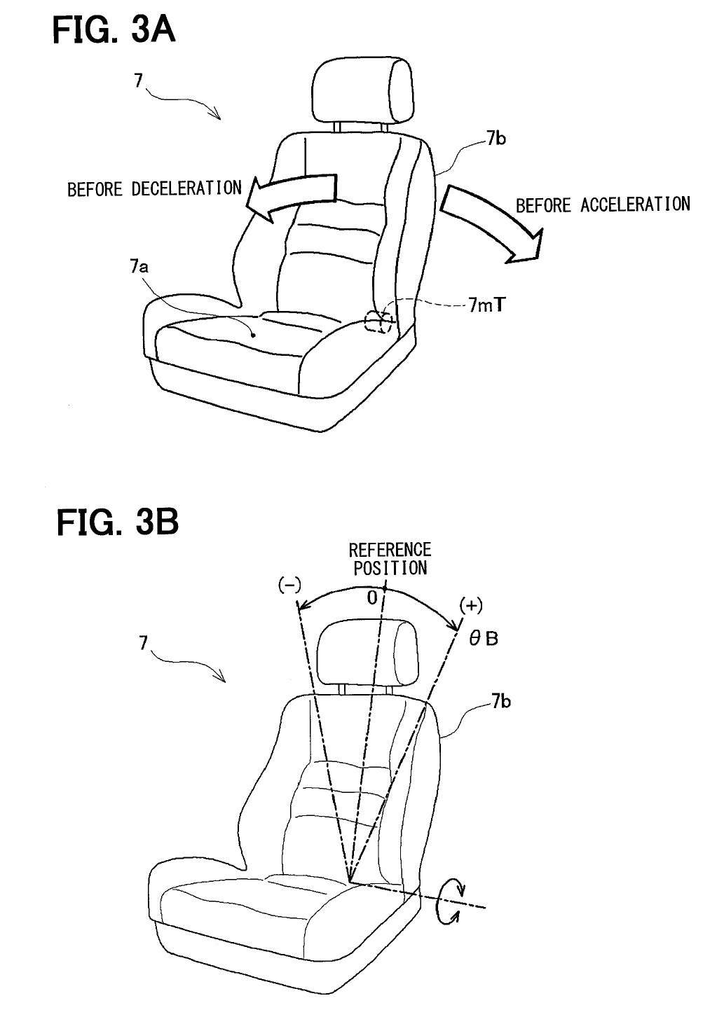

FIG. 3A and FIG. 3B illustrate how the host vehicle 1 is accelerated or decelerated by inclining a backrest portion 7b of the seat 7 of the present embodiment. As shown in FIG. 3A, an electric actuator 7mT is built in a place where the backrest portion 7b of the seat 7 is attached to a seat surface portion 7a. By driving the electric actuator 7mT, the backrest portion 7b can be inclined with respect to the seat surface portion 7a.

As described later, the autonomous driving control apparatus 100 according to the present embodiment drives the electric actuator 7mT so as to incline the backrest portion 7b backward when accelerating the host vehicle 1. Further, when decelerating the host vehicle 1, the electric actuator 7mT is driven so as to incline the backrest portion 7b forward.

As shown in FIG. 3B, the angle θB of the backrest portion 7b is assumed to be “positive” when the backrest portion 7b is inclined backward, and “negative” when the backrest portion 7b is inclined forward.

The electric actuator 7mT of the present embodiment corresponds to the “driving portion”.

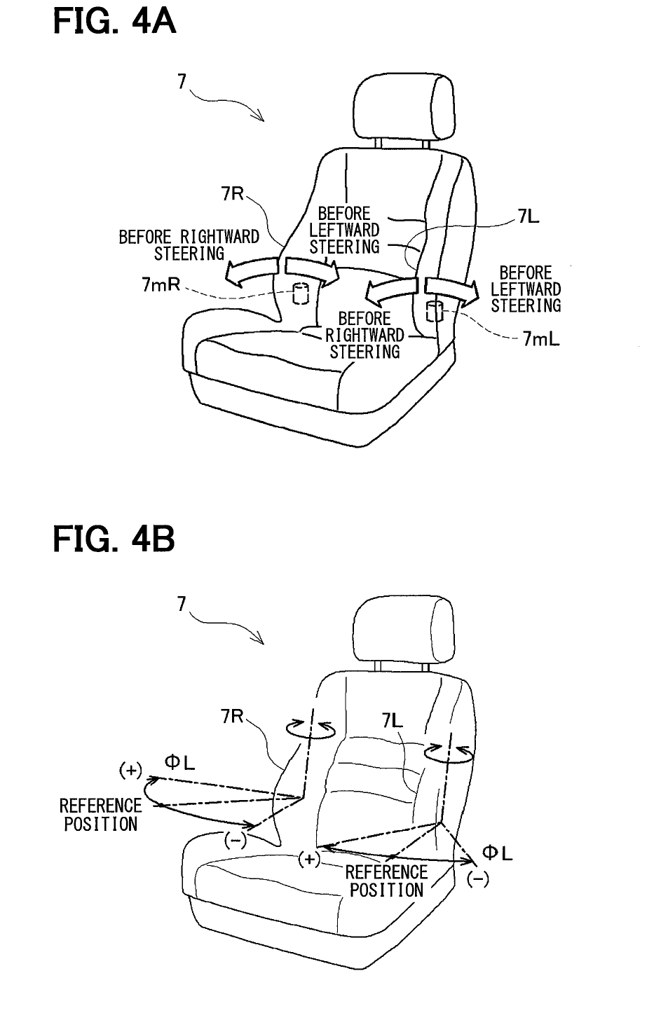

FIG. 4A and FIG. 4B illustrate how to present the rightward steering or the leftward steering of the host vehicle 1 by inclining lumbar support portions 7R, 7L of the seat 7 of the present embodiment. As shown in FIG. 4A, an electric actuator 7mR is incorporated in the lumbar support portion 7R on the right side of the seat 7, and an electric actuator 7mL is built in the lumbar support portion 7L on the left side thereof. By driving the electric actuators 7mR, 7mL, the right and left lumbar support portions 7R, 7L can be inclined to the left and right with respect to the backrest portion 7b.

As described later, when the host vehicle 1 is to be steered to the right, the autonomous driving control apparatus 100 of the present embodiment drives the electric actuators 7mR, 7mL so as to incline the right and left lumbar support portions 7R, 7L to the right as viewed from the occupant sitting on the seat 7. When the host vehicle 1 is to be steered to the left, the electric actuators 7mR, 7mL are driven so that the right and left lumbar support portions 7R, 7L are inclined to the left as viewed from the occupant sitting on the seat 7.

As shown in FIG. 4B, an angle ϕL of the lumbar support portions 7R, 7L is “positive” when the lumbar support portions 7R, 7L are inclined to the right. The angle ϕL of the lumbar support portions 7R, 7L is “negative” when the lumbar support portions 7R, 7L are inclined to the left.

The electric actuator 7mR and the electric actuator 7mL of the present embodiment also correspond to the “driving portion”.

The autonomous driving control apparatus 100 of the present embodiment drives the electric actuator 7mT built in the seat 7 to incline the backrest portion 7b, or drives the electric actuators 7mR, 7mL to incline the right and left lumbar support portions 7R, 7L, so as to be able to present driving information during the autonomous driving to the occupant sitting on the seat 7. As a result, it is possible to perform autonomous driving without providing a feeling of discomfort to the occupant sitting on the seat 7. Hereinafter, in order to achieve such a situation, processes executed by the autonomous driving control apparatus 100 of the present embodiment will be described.

In the present embodiment, a description will be given assuming that driving information is presented to the occupant of the seat 7 on the driver's seat side. The driving information may be presented to the occupant sitting on the seat 7 other than the driver's seat.

### B. Autonomous Driving Control Process

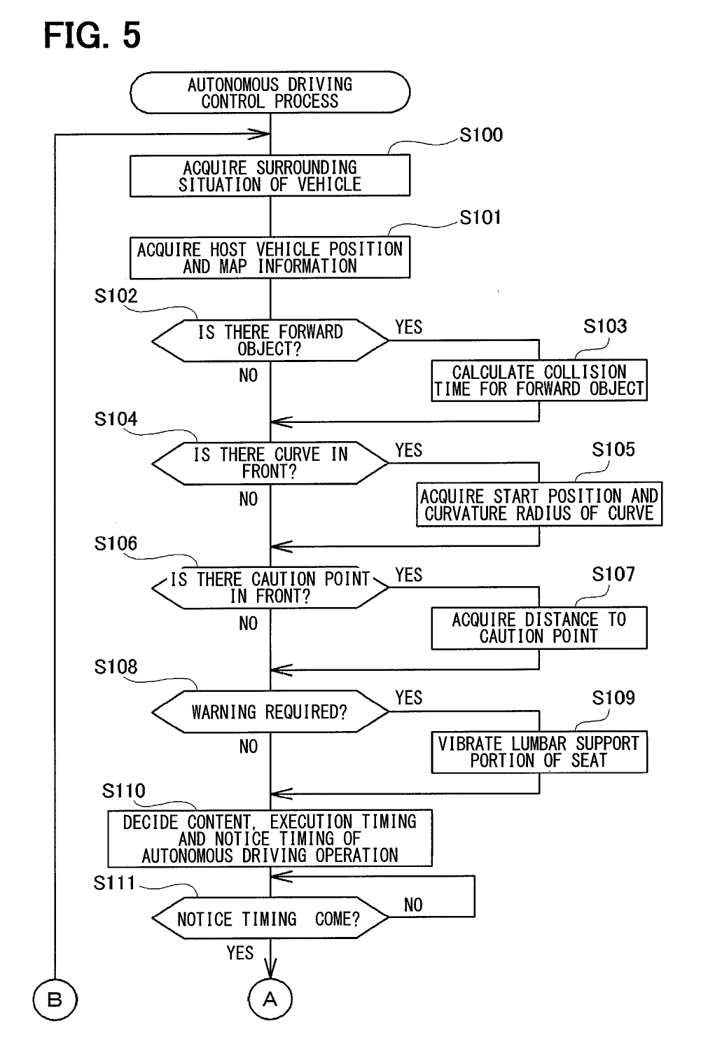

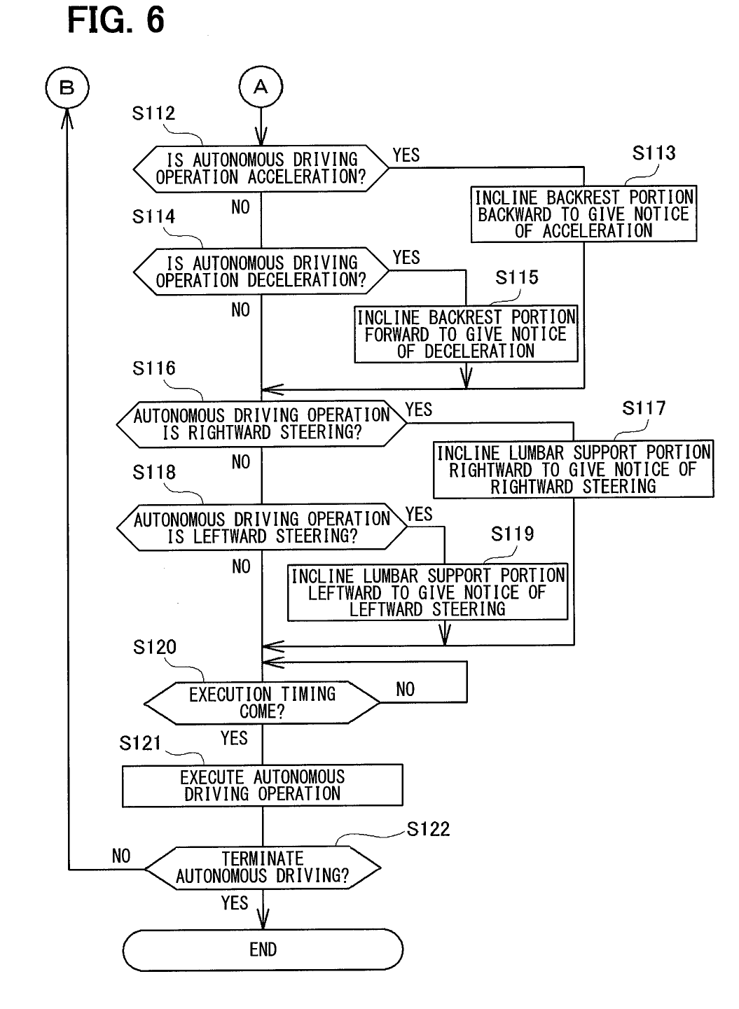

FIG. 5 and FIG. 6 are flowcharts of the autonomous driving control process executed by the autonomous driving control apparatus 100 of the present embodiment.

As shown in FIG. 5, in the autonomous driving control process, first, the surrounding situation of the host vehicle 1 is acquired (S100). As described above with reference to FIG. 2, in the autonomous driving control apparatus 100 of the present embodiment, the traveling environment acquisition module 110 is connected to the in-vehicle camera 2, the radar 3, the vehicle speed sensor 1t, the sunshine sensor 1s, and the wireless communication device 10. The traveling environment acquisition module 110 acquires the surrounding situation based on outputs of these. The present disclosure is not limited to this. A sonar or the like may be mounted in the host vehicle 1, and the surrounding situation may be acquired using these.

Subsequently, the current position of the host vehicle 1 (hereinafter, also referred to as the host vehicle position) and the surrounding map information including the host vehicle position are acquired from the navigation system 40 (S101). As described above with reference to FIG. 2, the traveling environment acquisition module 110 is also connected to the navigation system 40. It is possible to acquire the host vehicle position from the host vehicle position detection portion 41 of the navigation system 40, and to acquire the map information from the map information storage portion 42.

It is determined whether there is a forward object (that is, other vehicles, pedestrians, obstacles or the like existing in front) (S102). Whether there is a forward object can be determined by analyzing the captured image obtained from the in-vehicle camera 2 or analyzing the output of the radar 3.

As a result, when there is a forward object (S102: yes), collision time for the forward object is calculated (S103). The collision time can be calculated by dividing the distance from the host vehicle 1 to the forward object by a relative speed between the host vehicle 1 and the forward object. The distance from the host vehicle 1 to the forward object can be obtained based on the output of the radar 3. The relative speed between the host vehicle 1 and the forward object can be obtained based on a temporal change in the distance to the forward object.

In contrast, when there is no forward object (S102: no), it is determined whether a curve exists in front of the host vehicle 1 (S104) without calculating the collision time. Whether a curve exists can be determined by acquiring the shape of the road included in the map information. Alternatively, the road shape may be acquired by analyzing the image captured by the in-vehicle camera 2 and detecting a lane (or white line).

As a result, when there is a curve in front (S104: yes), the start position of the curve and the curvature radius of the curve are acquired (S105). The start position and the curvature radius of the curve can also be acquired from the map information. Alternatively, the start position and the curvature radius of the curve may be obtained based on the road shape acquired from the captured image by the in-vehicle camera 2.

On the other hand, when there is no curve in front of the host vehicle 1 (S104: no), it is determined whether a caution point exists in front of the host vehicle 1 without calculating the start position or the curvature radius of the curve (S106). Here, the caution point is a point where caution is required when the driver performs manual driving, such as an intersection, a tunnel entrance, a tunnel exit, an ending point of an ascending slope or the like. That is, it is known that an accident is likely to occur at an intersection, so that attention is required for driving. At the tunnel entrance and the tunnel exit, the brightness suddenly changes and the visibility is likely to be deprived, so that attention is required for driving. Further, at the ending point of the ascending slope, the line of sight gets worse due to the change from the ascending slope to a descending slope, so that attention is required for driving.

The reason for considering the presence of a caution point requiring caution when the driver manually drives during the autonomous driving is to autonomously drive without providing a feeling of discomfort to the driver. That is, the driver during manual driving tends to decelerate semi-reflectively at these caution points or to travel at a lower vehicle speed. For this reason, it is necessary to grasp the caution point that exists in front of the host vehicle 1 in order to autonomously drive without providing a feeling of discomfort to the driver even during the autonomous driving.

With the caution point stored in advance in the map information acquired from the navigation system 40, the autonomous driving control apparatus 100 can easily determine whether the caution point exists in front of the host vehicle 1. The presence or absence of a caution point in front may be determined based on information acquired from the outside by using the wireless communication device 10.

Also when a distant view is unclear due to heavy fog, heavy snow, heavy rain, or the like (that is, when the visibility is low), the driver tends to decelerate semi-reflectively or travel at a low vehicle speed. Therefore, by analyzing the image captured by the in-vehicle camera 2, the degree of visibility in the forward direction of the host vehicle 1 is detected, and when the degree of visibility becomes equal to or smaller than a predetermined value, it may be determined that the host vehicle 1 is reaching the caution point.

Alternatively, by communicating with the outside via the wireless communication device 10, it may be determined whether there is a point with a small visibility in front of the host vehicle 1, and when there is a point with a small visibility, a distance to that point may be acquired. When such a point exists within a certain distance from the host vehicle 1, it may be determined that a caution point exists.

As a result, when there is a caution point in front (S106: yes), the distance from the host vehicle 1 to the caution point is acquired (S107). Since the position at which the host vehicle 1 exists is known, when the position of the caution point is known, the distance from the host vehicle 1 to the caution point can be acquired with ease.

In contrast, when there is no caution point in front of the host vehicle 1 (S106: no), it is determined whether a warning is necessary for the occupant of the host vehicle 1 without acquiring the distance to the caution point (S108). For example, in a case where the collision time calculated in S103 is smaller than a predetermined time, a case where the distance to the start position of the curve acquired in S107 or the distance to the caution point acquired in S109 is smaller than a predetermined distance, or the like, it is determined that a warning is required (S108: yes).

As a result, when it is determined that a warning is necessary (S108: yes), a warning is issued by vibrating the right and left lumbar support portions 7R, 7L (S109). In the present embodiment, by driving the electric actuators 7mL, 7mR in mutually opposite directions, the right and left lumbar support portions 7R, 7L are vibrated.

A vibrator may be built in the lumbar support portions 7R, 7L, separately from the electric actuators 7mL, 7mR. The lumbar support portions 7R, 7L may be vibrated by driving the vibrator. Alternatively, the vibrator may be built in the seat surface portion 7a of the seat 7. The seat surface portion 7a may be vibrated by driving the vibrator.

In contrast, when the warning is unnecessary (S108: no), the content of the autonomous driving operation and the execution timing of the autonomous driving operation are decided (S110). For example, when a destination has been set in the navigation system 40, based on the information on the route shown by the navigation system 40 and the surrounding situation of the host vehicle 1, whether to operate the accelerator pedal 4, the brake pedal 5, and the steering wheel 6 is decided and the operation amount is decided.

When traveling to follow a preceding vehicle has been set, the surrounding situation of the host vehicle 1 including the position of the preceding vehicle is detected based on the captured image obtained by the in-vehicle camera 2 or based on the output of the radar 3, to decide whether to operate the accelerator pedal 4, the brake pedal 5, and the steering wheel 6, and decide the operation amount.

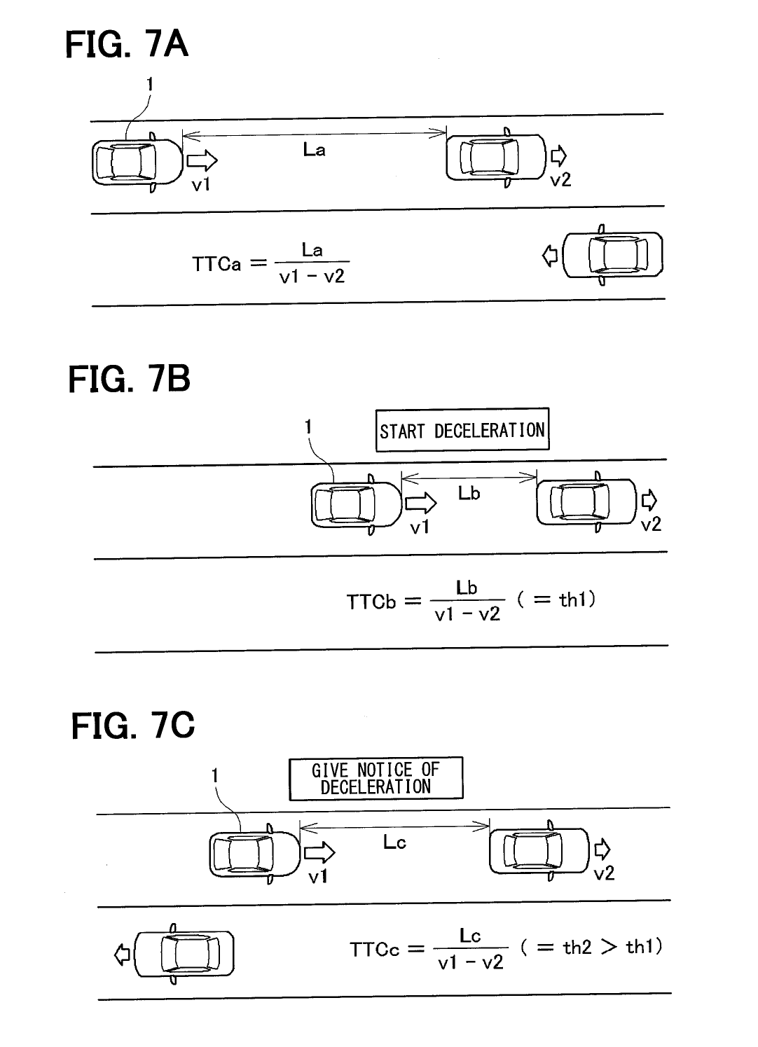

For example, as shown in FIG. 7A, it is assumed that another vehicle traveling at a speed v2, which is lower than a certain speed v1, is detected in front while traveling at the speed v1. In such a case, when the distance from the host vehicle 1 to another vehicle in front is La, collision time TTCa can be calculated by TTCa=a/(v1−v2).

In such a case, when the collision time TTCb becomes shorter to a first threshold time th1, it is decided to start deceleration with a deceleration rate in accordance with a relative speed (=v1−v2) (referring to FIG. 7B). When the time TTCc becomes shorter to a second threshold time th2 which is larger than the first threshold time th1, it is decided to give notice of deceleration (referring to FIG. 7C). In S110 of the autonomous driving control process in FIG. 5, the content of the autonomous driving operation (deceleration in this case), the execution timing of the autonomous driving operation, and the notice timing are decided in this manner.

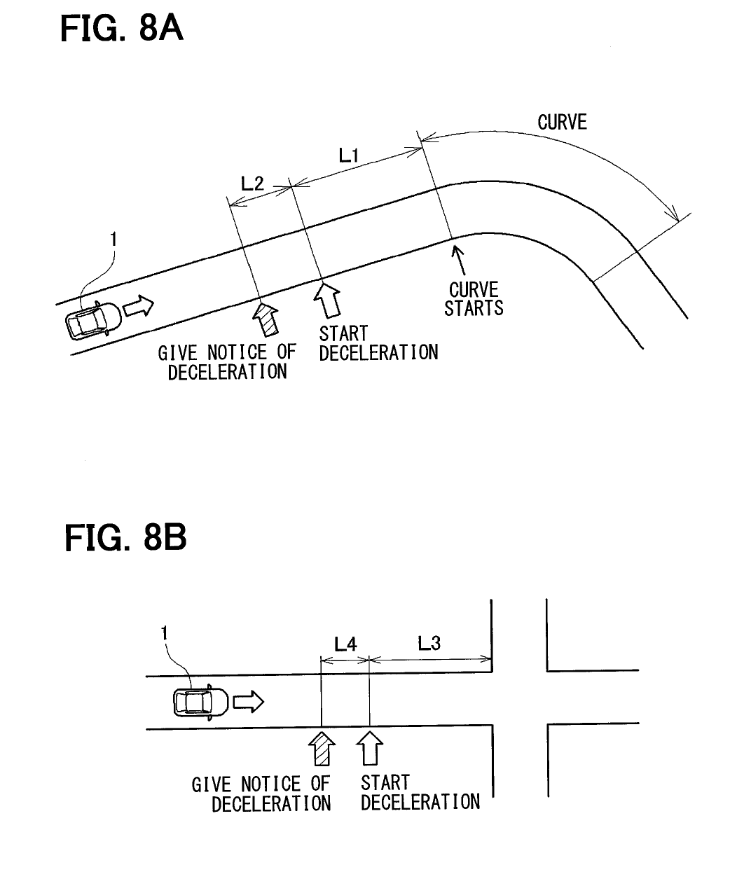

Also, as shown in FIG. 8A, assuming that a curve exists in front, the start position of the curve and the curvature radius of the curve are acquired in S105 of FIG. 5. Since an appropriate vehicle speed at the time of entering the curve (hereinafter referred to as entry speed) is decided in accordance with the curvature radius of the curve, the entry speed in accordance with the curvature radius is decided and compared with the vehicle speed of the host vehicle 1.

As a result, when the vehicle speed of the host vehicle 1 is larger than the entry speed, it is decided to decelerate at a deceleration rate in accordance with the speed difference between the vehicle speed of the host vehicle 1 and the entry speed at the point located before the start position of the curve by a distance L1. Further, it is decided to give notice of deceleration at a point located before the point, at which the deceleration is started, by a distance L2.

Alternatively, as shown in FIG. 8B, when there is an intersection without a traffic light in front, it is decided to decelerate at a deceleration rate in accordance with the vehicle speed of the host vehicle 1 at a point located before the position of the intersection by a distance L3, and to stop at the intersection. Further, it is decided to give notice of deceleration at a point before the point, at which the deceleration is started, by a distance L4.

In S110 of the autonomous driving control process of FIG. 5, the content of the autonomous driving operation, the execution timing of the autonomous driving operation, and the notice timing are decided in this manner. The content of the autonomous driving operation corresponds to “driving information”.

Subsequently, it is determined whether the notice timing decided in S110 has come (S111). As a result, when the notice timing has not come (S111: no), a standby state is set by repeating the determination of S111.

When it is determined that the notice timing has come (S111: yes), it is determined whether the decided content of the autonomous driving operation is acceleration (S112 of FIG. 6). As a result, when the content of the autonomous driving operation is acceleration (S112: yes), the electric actuator 7mT is driven in accordance with the degree of the acceleration, and the backrest portion 7b of the seat 7 is inclined backward to give notice of acceleration (S113). Here, “to incline the backrest portion 7b backward” means to incline the backrest portion 7b so as to be inclined backward.

In contrast, when the content of the autonomous driving operation is not acceleration (S112: no), it is determined whether the autonomous driving operation is deceleration (S114). As a result, when it is deceleration (S114: yes), the electric actuator 7mT is driven in accordance with the degree of the deceleration, and the backrest portion 7b of the seat 7 is inclined forward to give notice of deceleration (S115). Here, “to incline the backrest portion 7b forward” means to incline the backrest portion 7b so as to be raised forward.

FIG. 3A and FIG. 3B illustrate how to give notice of acceleration or deceleration by inclining the backrest portion 7b of the seat 7.

When the content of the autonomous driving operation is not acceleration or deceleration (S114: no), the electric actuator 7mT is not driven. As a result, the backrest portion 7b of the seat 7 is kept in the state of not being inclined in the forward or backward direction.

Subsequently, it is determined whether the content of the autonomous driving operation decided in S110 of FIG. 5 is steering of the steering wheel 6 in the right direction (hereinafter referred to as rightward steering) (S116). As a result, when it is rightward steering (S116: yes), the electric actuator 7mR and the electric actuator 7mL are driven in accordance with the steering amount of the steering wheel 6, and the lumbar support portion 7R and the lumbar support portion 7L are inclined to the right, to give notice of rightward steering (S117). Here, “be inclined to the right” means to be inclined to the right as seen from the occupant sitting on the seat 7.

In contrast, when the content of the autonomous driving operation is not rightward steering (S116: no), it is determined whether the content of the autonomous driving operation is steering of the steering wheel 6 in the left direction (hereinafter referred to as leftward steering) (S118). As a result, when it is leftward steering (S118: yes), the electric actuator 7mR and the electric actuator 7mL are driven in accordance with the steering amount, so that the lumbar support portion 7R and the lumbar support portion 7L are inclined to the left, to give notice of leftward steering (S119). Here, “be inclined to the left” means to be inclined to the left as seen from the occupant sitting on the seat 7.

FIG. 4A and FIG. 4B illustrate how to give notice of rightward steering or the leftward steering of the host vehicle 1 by inclining the lumbar support portion 7R and the lumbar support portion 7L to the right or the left.

On the other hand, when the content of the autonomous driving operation is not the rightward steering or the leftward steering (S118: no), the electric actuator 7mR or the electric actuator 7mL is not driven. As a result, the lumbar support portion 7R and the lumbar support portion 7L are kept in the state of not being inclined in the right or left direction.

When the backrest portion 7b and the lumbar support portions 7R, 7L of the seat 7 are inclined as described above, the movement thereof is recognized by the occupant sitting on the seat 7. The content thereof can be notified to the occupant prior to execution of the autonomous driving operation. Therefore, the occupant sitting on the seat 7 can recognize in advance the content of the autonomous driving operation to be performed, so as to be able to avoid a feeling of discomfort with autonomous driving.

Further, since the content of the autonomous driving operation is notified to the occupant by the movement of the backrest portion 7b and the lumbar support portions 7R, 7L of the seat 7, differently from a case where the content appeals to visual and auditory feelings, the occupant does not feel bothered. Therefore, even in the case of notifying the content of the driving operation one by one during the autonomous driving, the content can naturally be notified to the occupant without any burden.

In addition, even when the consciousness of the occupant is vague during the autonomous driving, by moving a part of the body (in this case, the back in contact with the backrest portion 7b and the waist part in contact with the lumbar support portions 7R, 7L), the occupant relatively clearly recognizes the content. Further, since it is possible to intuitively understand the content meant by the recognized movement (in this case, the movement of the backrest portion 7b and the lumbar support portions 7R, 7L), even for an occupant whose consciousness is vague, it is possible to cause the occupant to reliably recognize the content of the autonomous driving operation.

The angle θB at which the backrest portion 7b of the seat 7 is inclined is set to the following angle in accordance with the acceleration or deceleration of the host vehicle 1.

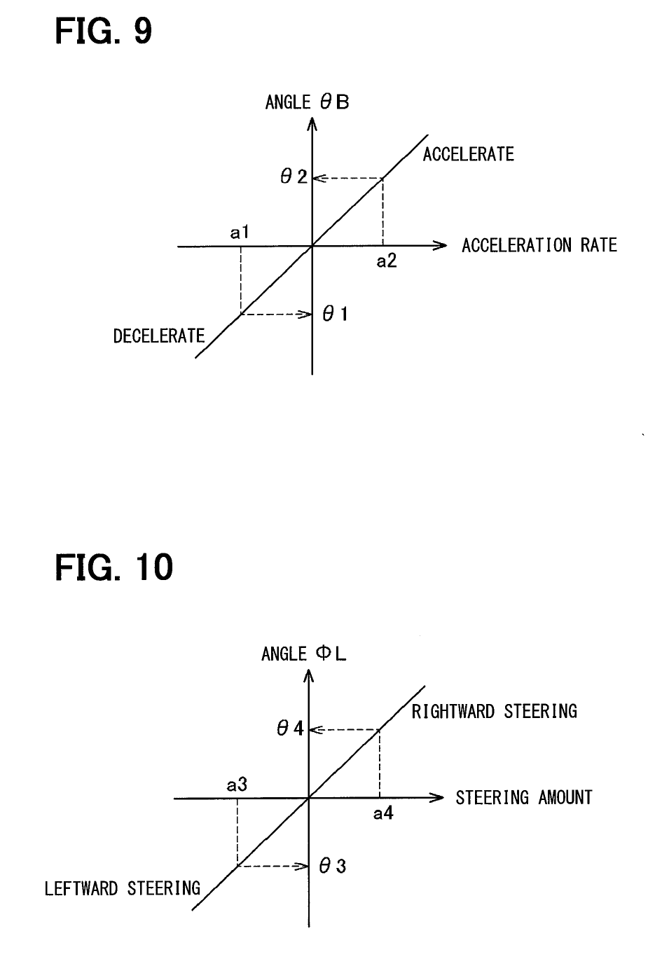

FIG. 9 illustrates the angle θB of the backrest portion 7b set in accordance with the degree of acceleration or deceleration. As described above with reference to FIG. 3A and FIG. 3B, the angle θB of the backrest portion 7b is set such that the direction in which the backrest portion 7b is inclined backward from a predetermined reference position is positive, and the direction in which the backrest portion 7b is raised from the reference position is negative.

As shown in the drawing, at the time of accelerating the host vehicle 1, the angle θB of the backrest portion 7b is set to a positive value. At the time of decelerating, the angle θB of the backrest portion 7b is set to a negative value. Moreover, as an absolute value of the acceleration rate increases, an absolute value of the angle θB is also set to a larger value. For this reason, the driver can recognize whether the host vehicle 1 is going to be accelerated or decelerated from the movement of the backrest portion 7b to be inclined forward or backward. Furthermore, it is possible to recognize the degree of acceleration or deceleration from the magnitude of the angle θB of the backrest portion 7b. After giving notice of acceleration or deceleration in this manner, the angle θB of the backrest portion 7b is returned to the reference position in preparation for the next notice of acceleration or deceleration. At this time, it may be preferable to set the speed, at which the backrest portion 7b is returned, to a speed small enough not to be noticed by the driver.

The angle θB of the backrest portion 7b corresponds to the “target position”.

The angle ϕL at which the right and left lumbar support portions 7R, 7L of the seat 7 are inclined is set to the following angle in accordance with the steering amount of the rightward steering or the leftward steering of the host vehicle 1.

FIG. 10 illustrates the angle ϕL of the lumbar support portions 7R, 7L set in accordance with the steering amount of the host vehicle 1. Here, as described above with reference to FIG. 4A and FIG. 4B, the angle ϕL at which the right and left lumbar support portions 7R, 7L are inclined is set such that the direction of inclination to the right from a predetermined reference position as viewed from the occupant sitting on the seat 7 is positive, and the direction of inclination to the left is negative.

As shown in the drawing, when steering the host vehicle 1 to the right, the angle ϕL of the lumbar support portions 7R, 7L is set to a positive value. When steering the host vehicle 1 to the left, the lumbar support portions 7R, 7L is set to a negative value. Therefore, the driver can recognize, from the direction in which the lumbar support portions 7R, 7L are inclined, whether the host vehicle 1 is going to be steered rightward or leftward. Further, the driver can also recognize the steering amount of the rightward steering or the leftward steering from the magnitude of the absolute value of the angle ϕL of the lumbar support portions 7R, 7L. After giving notice of the rightward steering or the leftward steering in this manner, the angle ϕL of the lumbar support portions 7R, 7L is returned to the reference position in preparation for the next notice of the rightward steering or the leftward steering. At this time, it may be preferable to set the speed, at which the lumbar support portions 7R, 7L are returned, to a speed small enough not to be noticed by the driver.

The angle ϕL of such lumbar support portions 7R, 7L also corresponds to the “target position”.

In S113, S115, S117, and S119 of FIG. 6, by inclining the backrest portion 7b and the lumbar support portions 7R, 7L as described above, notice of the content of the autonomous driving decided at S110 of FIG. 5 is given to the driver.

Thereafter, the autonomous driving control apparatus 100 executes autonomous driving operation by driving the accelerator pedal actuator 4m, the brake pedal actuator 5m, and the steering wheel actuator 6m in accordance with the content decided in S110 (S121).

Subsequently, the autonomous driving control apparatus 100 determines whether the autonomous driving is to be terminated (S122). When the autonomous driving is not terminated (S122: no), the autonomous driving control apparatus 100 returns to the beginning of the process to acquire the surrounding situation of the host vehicle 1 (S100 in FIG. 5), and executes the series of processes described above (S101 to S122). Then, when it is determined that the autonomous driving is terminated while such operation is repeated (S122: yes), the autonomous driving control process in FIG. 5 and FIG. 6 is terminated.

As described in detail above, when deciding the content of the autonomous driving operation, the autonomous driving control apparatus 100 of the present embodiment inclines the backrest portion 7b and the lumbar support portions 7R, 7L of the seat 7 in accordance with the content thereof. In this manner, the occupant of the host vehicle 1 can recognize in advance the content of the autonomous driving operation from the movement of the backrest portion 7b and the lumbar support portions 7R, 7L. Thus, even when the content of the autonomous driving operation is not the way of driving that the occupant feels natural, it is possible to avoid providing a feeling of discomfort to the occupant. As a result, even when the way of driving during the autonomous driving is different from the way of driving that the occupant feels natural, it is possible to autonomously drive the vehicle without providing a feeling of discomfort to the occupant.

In the above description, it has been described that the backrest portion 7b of the seat 7 is inclined greatly as the absolute value of the acceleration rate increases. It has been described that the lumbar support portions 7R, 7L are inclined greatly as the steering amount increases (referring to FIG. 9 and FIG. 10).

However, various contrivances can be devised for a mode in which the backrest portion 7b is inclined in accordance with the acceleration rate and a mode in which the lumbar support portions 7R, 7L are inclined in accordance with the steering amount.

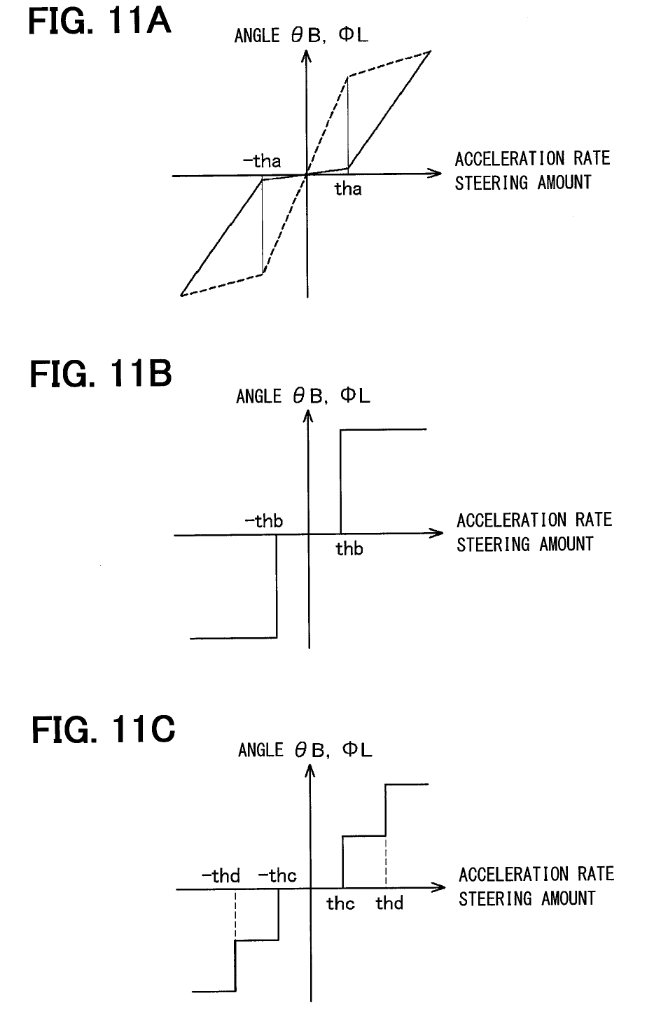

For example, as illustrated by a solid line in FIG. 11A, the inclination of the angle θB of the backrest portion 7b with respect to the acceleration rate may be varied between when the absolute value of the acceleration rate is equal to or smaller than a predetermined value tha and when it is equal to or larger than the predetermined value tha, and when the value is equal to or smaller than the predetermined value tha, the inclination may be made smaller than when the value is equal to or larger than the predetermined value tha.

Likewise for the angle ϕL of the lumbar support portions 7R, 7L, as illustrated by a solid line in the drawing, the inclination of the angle ϕL of the lumbar support portions 7R, 7L with respect to the steering amount may be varied between when the absolute value of the steering amount is equal to or smaller than a predetermined value tha and when it is equal to or larger than the predetermined value tha. The inclination when the value is equal to or smaller than the predetermined value tha may be made smaller than when the value is equal to or larger than the predetermined value tha.

In this manner, with a small acceleration/deceleration or steering amount, it is possible to prevent the driver from recognizing the movement of the backrest portion 7b and the lumbar support portions 7R, 7L, or being bothered by the movement. There is thus no possibility that the driver feels annoyed when the backrest portion 7b and the lumbar support portions 7R, 7L move every time of small acceleration/deceleration or steering.

In FIG. 11A, the absolute value of the acceleration rate or the steering amount is represented such that the angle θB or the angle ϕL changes even in a range smaller than the predetermined value tha, but the angle θB or the angle ϕL may not change in the range smaller than the predetermined value tha.

Alternatively, as illustrated by a broken line in FIG. 11A, when the absolute value of the acceleration rate is equal to or smaller than the predetermined value tha, the inclination of the angle θB of the backrest portion 7b with respect to the acceleration rate may be made larger than that when the absolute value is equal to or larger than the predetermined value tha.

Likewise for the angle ϕL of the lumbar support portions 7R, 7L, as illustrated by a broken line in the drawing, when the absolute value of the steering amount is equal to or smaller than the predetermined value tha, the angle ϕL of the lumbar support portions 7R, 7L with respect to the steering amount may be larger than that when the absolute value is equal to or larger than the predetermined value tha.

In this manner, the driver can clearly recognize the notice of the detailed driving operation given by the autonomous driving control apparatus 100 during the autonomous driving by the movement of the backrest portion 7b and the lumbar support portions 7L, 7R.

Further, as illustrated in FIG. 11B, when the absolute value of the acceleration rate or the steering amount is larger than a predetermined value thb as a boundary, the backrest portion 7b and the lumbar support portions 7R, 7L are inclined to a certain angle. When the absolute value of the acceleration rate or the steering amount is smaller than that, the backrest portion 7b or the lumbar support portions 7R, 7L may not be inclined.

In this manner, in the case of acceleration/deceleration or steering where the necessity for giving notice to the driver is low, the backrest portion 7b and the lumbar support portions 7R, 7L do not move, so that the driver does not feel annoyed. In the case of acceleration/deceleration or steering where the necessity for giving notice to the driver is high, the backrest portion 7b and the lumbar support portions 7R, 7L greatly move at a certain angle, so that the driver can clearly recognize that the host vehicle 1 is going to be accelerated or decelerated, or steered.

Further, as illustrated in FIG. 11C, the backrest portion 7b and the lumbar support portions 7R, 7L may be inclined in multiple stages. For example, describing a case where the host vehicle 1 is going to be accelerated, when the acceleration rate is larger than thc, the backrest portion 7b is inclined backward at a certain angle. When the acceleration rate is larger than thd being even larger, the backrest portion 7b may be inclined backward to even a larger angle.

Likewise for the case of steering the host vehicle 1, when the steering amount is larger than thc, the lumbar support portions 7R, 7L are inclined at a certain angle. When the steering amount is larger than thd being even larger, the lumbar support portions 7R, 7L may be inclined to an even larger angle.

In this manner, the driver can roughly recognize the degree of acceleration/deceleration and steering from the rough movement of the backrest portion 7b and the lumbar support portions 7R, 7L, so as to appropriately recognize the content of the autonomous driving to a necessary and sufficient extent.

Alternatively, by vibrating the inclination of the backrest portion 7b and the lumbar support portions 7R, 7L, the degree of acceleration/deceleration and steering may be notified to the driver.

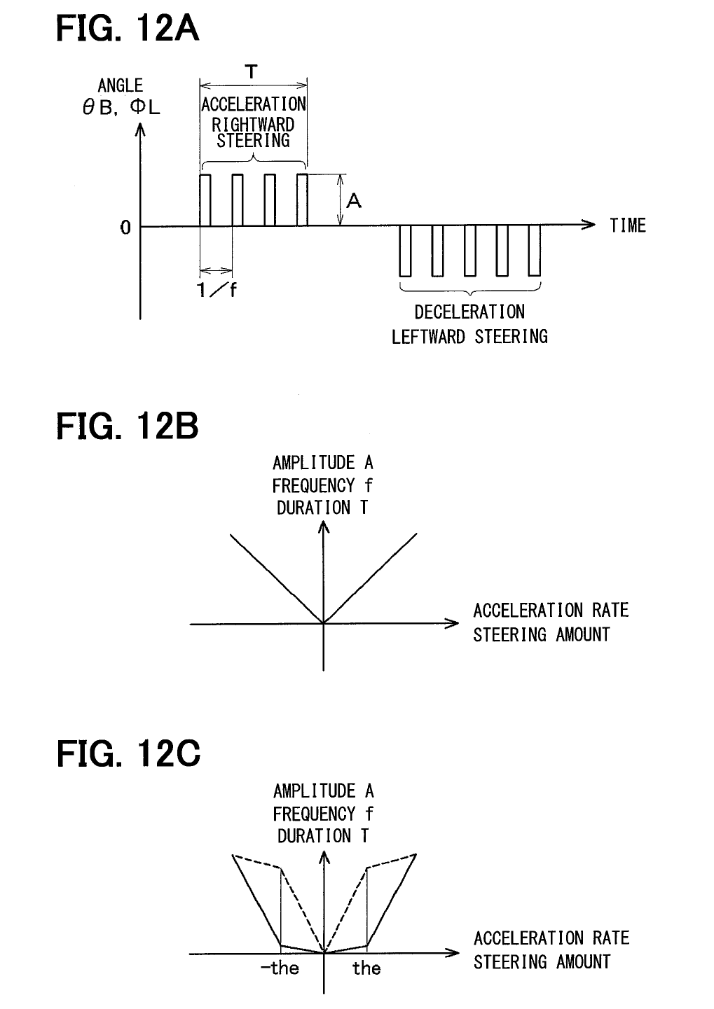

For example, in the case of accelerating and decelerating the host vehicle 1, as illustrated in FIG. 12A, when the host vehicle 1 is to be accelerated, the backrest portion 7b is vibrated by being repeatedly inclined in the positive direction (that is, backward) and returned to the original angle. When the host vehicle 1 is to be decelerated, the backrest portion 7b is vibrated by being repeatedly raised in the negative direction (that is, forward), and returned to the original angle. This enables the driver to recognize whether the host vehicle 1 is going to be accelerated or decelerated in accordance with the direction in which the backrest portion 7b vibrates.

Likewise for the case of steering the host vehicle 1, when rightward steering is to be performed, the lumbar support portions 7R, 7L are vibrated by being repeatedly inclined in the positive direction (that is, the right direction) and returned to the original position. When leftward steering is to be performed, the lumbar support portions 7R, 7L are vibrated by being repeatedly inclined in the negative direction (that is, the left direction) and returned to the original position. This enables the driver to recognize whether the host vehicle 1 is going to be steered rightward or leftward in accordance with the direction in which the lumbar support portions 7R, 7L vibrate.

Further, an amplitude A for vibrating the backrest portion 7b and the lumbar support portions 7R, 7L, a frequency f for vibration, and a duration T of vibration may be changed in accordance with the degree of acceleration/deceleration or the degree of steering. For example, as illustrated in FIG. 12B, the backrest portion 7b may be vibrated in such a mode that at least one of the amplitude A, the frequency f, and the duration T becomes larger as the absolute value of the acceleration rate or the acceleration rate increases.

Alternatively, the lumbar support portions 7R, 7L may be vibrated in such a mode that at least one of the amplitude A, the frequency f, and the duration T becomes larger as the steering amount increases. In this manner, the driver can recognize the degree of acceleration/deceleration and steering from the mode in which the backrest portion 7b and the lumbar support portions 7R, 7L vibrate.

Further, the amount of change in the amplitude A, the amount of change in the frequency f, or the amount of change in the duration T at the time when the absolute value of the acceleration rate changes by the unit amount may be varied between the range where the absolute value of the acceleration rate is smaller than a threshold the and the range where the absolute value is larger than the threshold the. Likewise for the steering amount, the amount of change in the amplitude A, the amount of change in the frequency f, or the amount of change in the duration T at the time when the steering amount changes by the unit amount may be varied between the range where the steering amount is smaller than a threshold the and the range where the steering amount is larger than the threshold the.

That is, as illustrated by a solid line in FIG. 12C, as for the acceleration rate, in the range where the absolute value of the acceleration rate is smaller than the threshold the, the amounts of change in the amplitude A, the frequency f, and the duration T with respect to the change in the unit amount of the acceleration rate may be made smaller than those in the range where the absolute value is larger than the threshold the. Likewise for the steering amount, in the range where the steering amount is smaller than the threshold the, the amounts of change in the amplitude A, the frequency f, and the duration T with respect to the change in the unit amount of the acceleration rate may be made smaller than those in the range where the absolute value is larger than the threshold the.

In this manner, with small acceleration/deceleration or steering amount, it is possible to prevent the driver from recognizing the vibration of the backrest portion 7b and the lumbar support portions 7R, 7L, or being bothered by the vibration. There is thus no possibility that the driver feels annoyed when the backrest portion 7b and the lumbar support portions 7R, 7L vibrates every time of small acceleration/deceleration or steering.

Alternatively, as illustrated by a broken line in FIG. 12C, when the absolute value of the acceleration rate is equal to or smaller than the predetermined value the, the amounts of change in the amplitude A, the frequency f, and the duration T with respect to the change in the unit amount of acceleration rate may be made larger than those when the absolute value is equal to or larger than the predetermined value the.

Likewise for the angle ϕL of the lumbar support portions 7R, 7L, as illustrated by a broken line in the drawing, when the absolute value of the steering amount is equal to or smaller than the predetermined value the, the amount of change in the amplitude A, the frequency f, and the duration T with respect to the change in the unit amount of the steering amount may be made larger than those when the absolute value is equal to or larger than the predetermined value the.

In this manner, the driver can clearly recognize the notice of the detailed driving operation given by the autonomous driving control apparatus 100 during the autonomous driving by the movement of the backrest portion 7b and the lumbar support portions 7L, 7R.

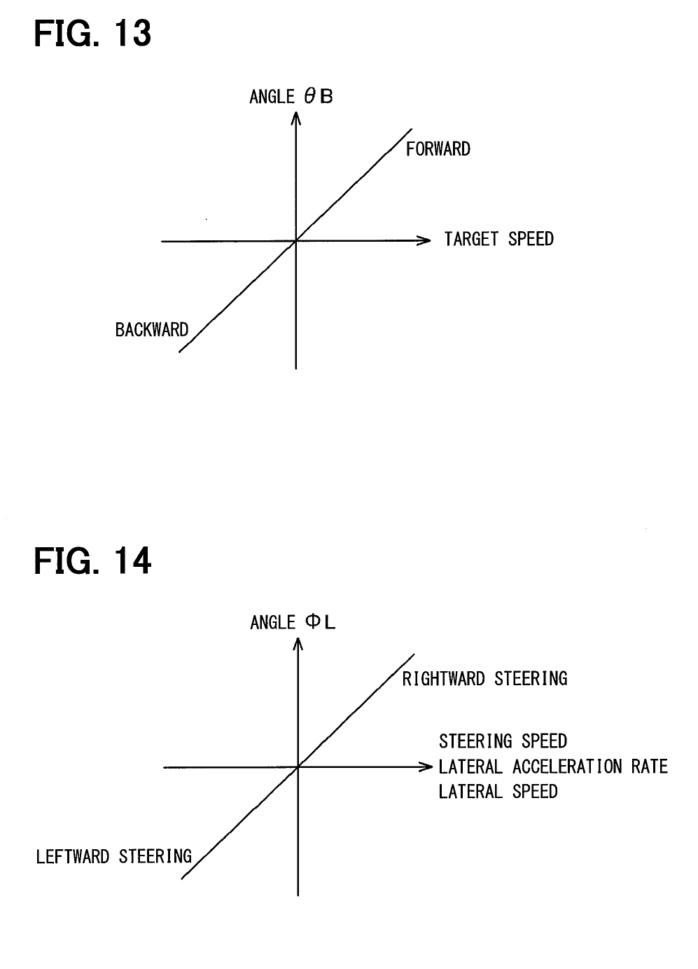

Alternatively, similarly to the content illustrated in FIG. 13, the backrest portion 7b may be inclined so that the angle θB of the backrest portion 7b becomes an angle in accordance with the control target value (that is, the target vehicle speed) of the vehicle speed of the host vehicle 1. Even in this case, the driver can recognize the target vehicle speed from the inclination of the backrest portion 7b.

Even when the backrest portion 7b is to be inclined in accordance with the target vehicle speed, as in the case of the inclination in accordance with the acceleration rate, the angle θB at which the backrest portion 7b is inclined with respect to the target vehicle speed can be set in various modes. For example, as in the case described above with reference to FIG. 11A, when the absolute value of the target vehicle speed is smaller than the predetermined threshold, the amount of change in the angle θB with respect to the amount of change in the target vehicle speed may be made smaller than that when the absolute value is larger than the predetermined threshold. Alternatively, as in the case described above with reference to FIG. 11 B and FIG. 11C, the angle θB may be varied stepwise with respect to the target vehicle speed.

Further, as in the case described above with reference to FIG. 12A to FIG. 12C, the driver may be notified by vibration of the backrest portion 7b that the target vehicle speed is to be changed. At this time, the backrest portion 7b may be vibrated in the positive direction (that is, backward) when the target vehicle speed is to be increased. The backrest portion 7b may be vibrated in the negative direction (that is, forward) when the target vehicle speed is to be decreased. This enables the driver to recognize whether the target vehicle speed is going to be increased or decreased in accordance with the direction in which the backrest portion 7b vibrates.

Further, the amplitude A for vibrating the backrest portion 7b, the frequency f for vibration, and the duration T of vibration may be changed in accordance with the target vehicle speed. For example, similarly to the content illustrated in FIG. 12B or FIG. 12C, the backrest portion 7b may be vibrated in such mode that at least one of the amplitude A, the frequency f, and the duration T increases as the absolute value of the target vehicle speed increases. At this time, the amount of change in the amplitude A, the amount of change in the frequency f, or the amount of change in the duration T at the time when the target vehicle speed changes by the unit amount may be varied in accordance with whether the absolute value of the target vehicle speed is smaller than the predetermined threshold speed.

Further, as illustrated in FIG. 14, the lumbar support portions 7R, 7L may be inclined so that the angle ϕL at which the lumbar support portions 7R, 7L are inclined becomes an angle determined in accordance with the steering speed of the host vehicle 1. Even in this case, the driver can recognize the steering direction and the steering speed from the inclination of the lumbar support portions 7R, 7L.

When the steering speed is decided, the rate of acceleration in the lateral direction (hereinafter referred to as lateral acceleration rate) or the speed in the lateral direction (hereinafter referred to as lateral speed) to be generated in the host vehicle 1 by steering is decided. The lumbar support portions 7R, 7L may be inclined to set the angle to an angle in accordance with the lateral acceleration rate or the lateral speed. Even in this case, the driver can recognize in which direction the host vehicle 1 is going to be steered at what degree of speed from the inclination of the lumbar support portions 7R, 7L.

The autonomous driving control apparatus 100 decides the content of the autonomous driving operation, and does not decide the lateral acceleration rate or the lateral speed of the host vehicle 1. However, since the lateral acceleration rate and the lateral speed are decided by the autonomous driving control apparatus 100 deciding the steering amount and the steering speed as the content of the autonomous driving operation, the lateral acceleration rate and the lateral speed can be considered as being indirectly decided by the autonomous driving control apparatus 100. Therefore, the steering amount and the steering speed to be directly decided by the autonomous driving control apparatus 100 and the lateral acceleration rate and the lateral speed to be indirectly decided are collectively referred to as “steering information” in some cases.

Also in the case of inclining the lumbar support portions 7R, 7L in accordance with the steering speed, the lateral acceleration rate, and the lateral speed, the angle ϕL at which the lumbar support portions 7R, 7L are inclined can be set in various modes, as in the case of inclination in accordance with the steering amount. For example, as in the case described above with reference to FIG. 11A, when the absolute values of the steering speed, the lateral acceleration rate, and the lateral speed are smaller than the predetermined thresholds, the amounts of change in the angle ϕL with respect to the amount of change in the steering speed, the lateral acceleration rate, and the lateral speed may be made smaller than those when the absolute values are larger than the predetermined thresholds. Alternatively, as in the case described above with reference to FIG. 11B and FIG. 11C, the angle ϕL may be varied stepwise with respect to the steering speed, the lateral acceleration rate, and the lateral speed.

Further, similarly to the case described above with reference to FIG. 12A to FIG. 12C, by vibrating the lumbar support portions 7R, 7L, the driver may be notified that the steering speed, the lateral acceleration rate, and the lateral speed are to be changed. At this time, when the steering speed, the lateral acceleration rate, and the lateral speed are to be increased, the lumbar support portions 7R, 7L may be vibrated in the positive direction (that is, rightward as viewed from the occupant sitting on the seat 7). When the steering speed, the lateral acceleration rate, and the lateral speed are to be decreased, the lumbar support portions 7R, 7L may be vibrated in the negative direction (that is, leftward as viewed from the occupant sitting on the seat 7).

This enables the driver to recognize whether the steering speed, the lateral acceleration rate, and the lateral speed are going to be increased or decreased in accordance with the direction in which the lumbar support portions 7R, 7L vibrate.

Further, the amplitude A for vibrating the lumbar support portions 7R, 7L, the frequency f for vibration, and the duration T of vibration may be changed in accordance with the steering speed, the lateral acceleration rate, and the lateral speed. For example, similarly to the content illustrated in FIG. 12B or FIG. 12C, the lumbar support portions 7R, 7L may be vibrated in such a mode that at least one of the amplitude A, the frequency f, and the duration T increases as the absolute values of the steering speed, the lateral acceleration rate, and the lateral speed increase. At this time, the amount of change in the amplitude A, the amount of change in the frequency f, or the amount of change in the duration T at the time when the target vehicle speed changes by the unit amount may be varied in accordance with whether the absolute values of the steering speed, the lateral acceleration rate, and the lateral speed are smaller than the predetermined threshold speeds.

Further, when there are multiple (two in this example) parts to be inclined like the lumbar support portions 7R, 7L of the seat 7, the lumbar support portions 7R, 7L may each take part to give notice of the content of the driving operation.

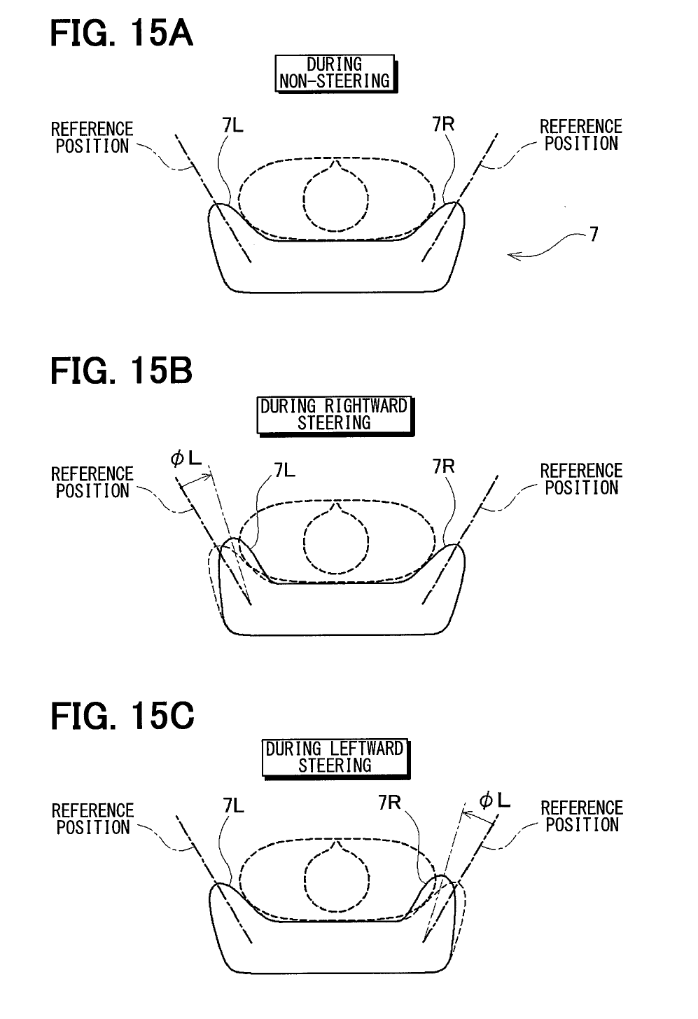

FIG. 15A to FIG. 15C illustrate how the right and left lumbar support portions 7R, 7L each take part to give notice of the content of steering. FIG. 15A to FIG. 15C show the movement of the right and left lumbar support portions 7R, 7L with the seat 7 viewed from above. A broken line indicated in the drawing represents the occupant sitting on the seat 7.

When the host vehicle 1 is not to be steered, as shown in FIG. 15A, both the right lumbar support portion 7R and the left lumbar support portion 7L are positioned at reference positions.

In contrast, when the host vehicle 1 is to be steered rightward, as shown in FIG. 15B, while the right lumbar support portion 7R remains at the reference position, the left lumbar support portion 7L is inclined in the positive direction (the right direction as viewed from the occupant sitting on the seat 7).

In this manner, with the right lumbar support portion 7R supporting the right side of the occupant, the left lumbar support portion 7L is inclined to push the left side of the occupant in the right direction. Therefore, the occupant can clearly recognize that the lumbar support portion 7L is inclined to the right. As a result, the occupant can easily recognize that the host vehicle 1 is going to be steered to the right.

When the host vehicle 1 is to be steered leftward, as shown in FIG. 15C, while the left lumbar support portion 7L remains at the reference position, the right lumbar support portion 7R is inclined in the negative direction (the left direction as viewed from the occupant sitting on the seat 7).

In this manner, with the left lumbar support portion 7L supporting the left side of the occupant, the right lumbar support portion 7R is inclined to push the right side of the occupant in the left direction. Therefore, the occupant can clearly recognize that the lumbar support portion 7R is inclined to the left. As a result, the occupant can easily recognize that the host vehicle 1 is going to be steered to the left.

### C. Modifications

### C-1. First Modification

In the embodiment described above, the description has been given such that the backrest portion 7b or the lumbar support portions 7R, 7L of the seat 7 is inclined with respect to the occupant sitting on the seat 7 so that the occupant recognizes the content of the autonomous driving operation. However, instead of inclining the backrest portion 7b or the lumbar support portions 7R, 7L, the entire seat 7 may be translated.

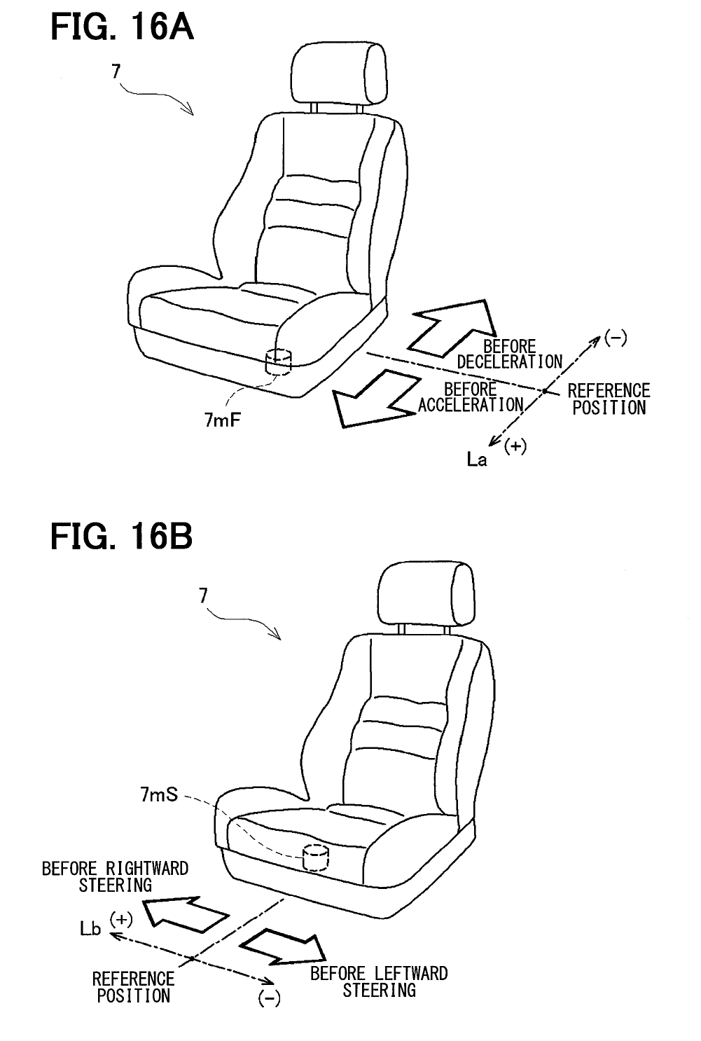

FIG. 16A and FIG. 16B illustrate a first modification in which the seat 7 is translated in accordance with the content of the autonomous driving operation.

For example, in FIG. 16A, the seat 7 is provided so as to be slidable in the front-back direction. By driving an electric actuator 7mF built in the seat 7, the seat 7 is configured to be translated in the front-back direction.

The electric actuator 7mF of the present modification also corresponds to the “driving portion”.

In such a first modification, when the content of the autonomous driving operation is acceleration, the seat 7 is moved in the positive direction from the reference position (that is, the forward direction as viewed from the occupant sitting on the seat 7). When the content of the autonomous driving operation is deceleration, the seat 7 is moved in the negative direction from the reference position (that is, the backward direction as viewed from the occupant sitting on the seat 7). This enables the occupant to recognize whether the host vehicle 1 is going to be accelerated or decelerated.

The target position La for moving the seat 7 at this time corresponds to the “target position”.

Alternatively, as shown in FIG. 16B, the seat 7 may be provided so as to be slidable in the right-left direction. The seat 7 may be translated in the right-left direction by driving an electric actuator 7mS built in the seat 7.

The electric actuator 7mS of the present modification also corresponds to the “driving portion”.

Even in such a case, when the content of the autonomous driving operation is rightward steering, the seat 7 is moved in the positive direction from the reference position (that is, in the right direction as viewed from the occupant sitting on the seat 7). When the content of the autonomous driving operation is leftward steering, the seat 7 is moved in the negative direction from the reference position (that is, in the left direction as viewed from the occupant sitting on the seat 7). This enables the occupant to recognize whether the host vehicle 1 is going to be steered rightward or leftward.

Further, instead of sliding the seat 7 in the right-left direction, the seat 7 may be rotated in the right-left direction.

The target position Lb for moving the seat 7 at this time, or the target rotational position for rotating the seat 7 also corresponds to the “target position”.

Further, in the first modification described above, the mode in which the seat 7 is moved in the front-back direction or the right-left direction in accordance with the magnitude of the acceleration rate or the steering amount can be variously modified as in the present embodiment described above.

That is, as in the case described above with reference to FIG. 9 and FIG. 10, the magnitude of the acceleration rate or the steering amount may be proportional to the movement amount of the seat 7. Alternatively, as in the case described above with reference to FIG. 11A, when the absolute value of the acceleration rate or the steering amount is smaller than the predetermined threshold, the amount of change in the moving amount with respect to the amount of change in the acceleration rate or the steering amount may be made smaller than that when the absolute value is larger than the predetermined threshold. Alternatively, as in the case described above with reference to FIG. 11B and FIG. 11C, the movement amount may be varied stepwise with respect to the acceleration rate or the steering amount.

Further, as in the case described above with reference to FIG. 12, the driver may be notified that acceleration or deceleration is going to be performed by vibration of the entire seat 7 forward and backward or rightward and leftward. At this time, the amplitude A for vibrating the entire seat 7 forward and backward or rightward and leftward, the frequency f for vibration, and the duration T of the vibration may be changed in accordance with the acceleration rate or the steering amount.

### C-2. Second Modification

Although the description has been given assuming that the entire seat 7 is translated in the above first modification, the entire seat 7 may be inclined instead of being translated.

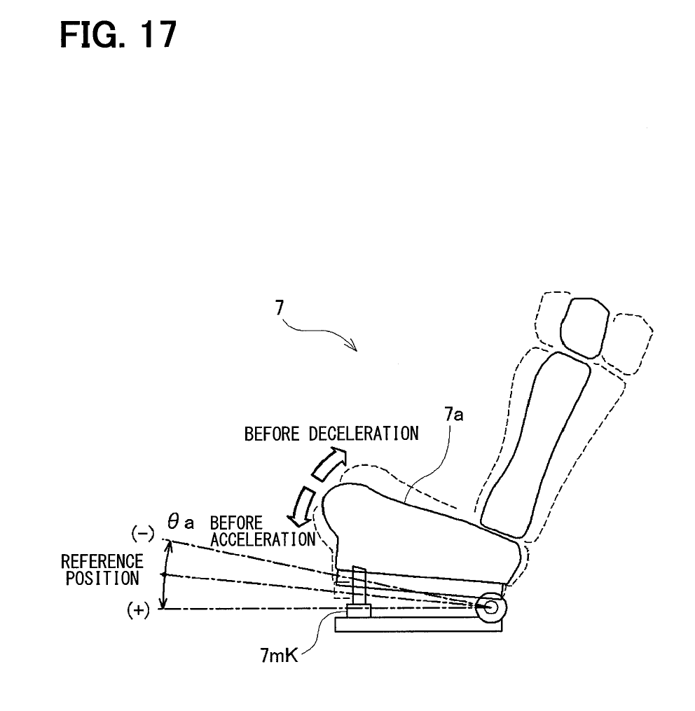

FIG. 17 illustrates a second modification in which the entire seat 7 is inclined in accordance with the content of the autonomous driving operation.

As shown in the drawing, in the second modification, an electric actuator 7mK is built in the front lower portion of the seat surface portion 7a of the seat 7. When the electric actuator 7mK is driven to lift the front side of the seat surface portion 7a, the entire seat 7 is inclined with the back side of the seat surface portion 7a as a rotation axis.

The electric actuator 7mK of the present modification also corresponds to the “driving portion”.

Also in such a second modification, when the content of the autonomous driving operation is acceleration, the seat 7 is rotated in the positive direction from the reference position (that is, in the direction in which the front of the seat surface portion 7a descends), and when the content of the autonomous driving operation is deceleration, the seat 7 is rotated in the negative direction from the reference position (that is, in the direction in which the front of the seat surface portion 7a ascends). This enables the occupant to recognize whether the host vehicle 1 is going to be accelerated or decelerated.

The target rotation angle θa for rotating the seat 7 at this time also corresponds to the “target position”.

Further, also in the second modification described above, the mode in which the seat 7 is rotated in accordance with the magnitude of the acceleration rate can be variously modified as in the present embodiment described above.

That is, as in the case described above with reference to FIG. 9, the magnitude of the acceleration rate may be proportional to the angle at which the seat 7 is rotated. Alternatively, as in the case described above with reference to FIG. 11A, when the absolute value of the acceleration rate is smaller than the predetermined threshold, the amount of change in the angle with respect to the amount of change in the acceleration rate may be made smaller than that when the absolute value is larger than the predetermined threshold. Alternatively, as in the case described above with reference to FIG. 11B and FIG. 11C, the angle at which the seat 7 is rotated may be varied stepwise with respect to the acceleration rate.

Further, as in the case described above with reference to FIG. 12, the driver may be notified that acceleration or deceleration is going to be performed, by vibration of the entire seat 7. At this time, the amplitude A for vibrating the entire seat 7, the frequency f for vibration, and the duration T of the vibration may be changed in accordance with the acceleration rate.

### C-3. Third Modification

It is also possible to give notice of the content of the autonomous driving operation by moving a headrest 7h.

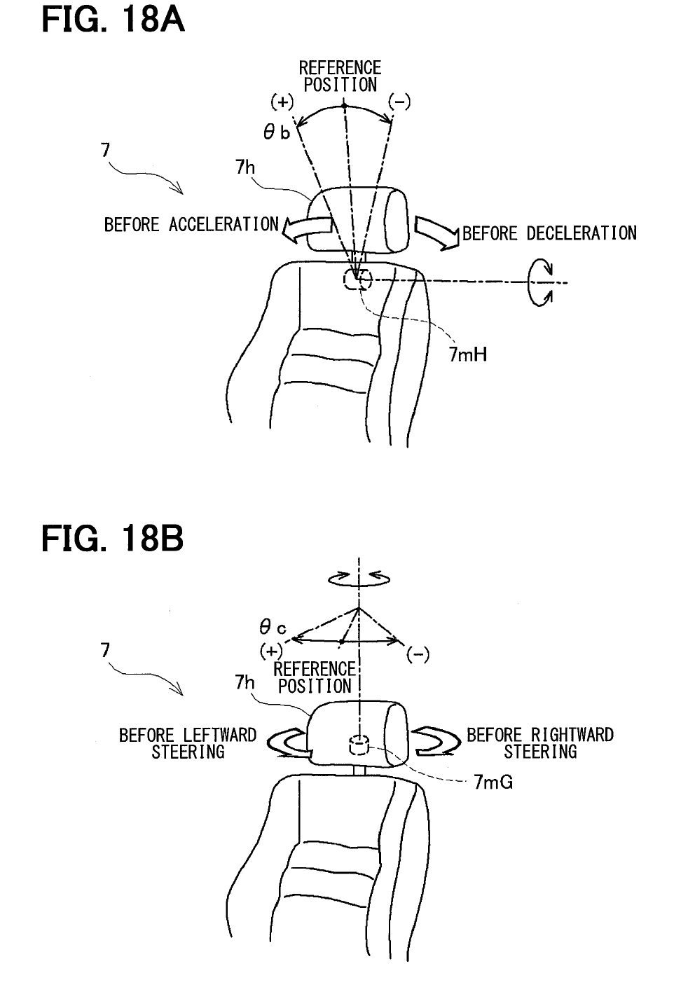

FIG. 18A and FIG. 18B illustrate a third modification in which the headrest 7h is moved in accordance with the content of the autonomous driving operation.

For example, in FIG. 18A, the headrest 7h is provided so as to be inclined in the front-back direction with respect to the seat 7, and by driving an electric actuator 7mH built in the seat 7, the headrest 7h can be inclined in the front-back direction.

Also in such a third modification, when the content of the autonomous driving operation is acceleration, the headrest 7h is rotated in the positive direction from the reference position (that is, the direction in which the headrest 7h moves forward), and when the content of the autonomous driving operation is deceleration, the headrest 7h is rotated in the negative direction from the reference position (that is, the direction in which the headrest 7h moves backward). This enables the occupant to recognize whether the host vehicle 1 is going to be accelerated or decelerated.

The target rotation angle θb for rotating the headrest 7h at this time also corresponds to the “target position”.

Alternatively, as shown in FIG. 18B, the headrest 7h may be provided so as to be rotatable in the right-left direction and the headrest 7h may be rotated in the right-left direction by driving an electric actuator 7mG built in the headrest 7h.

In such a case, when the content of the autonomous driving operation is rightward steering, the headrest 7h is rotated in the positive direction from the reference position (that is, the right direction as viewed from the occupant sitting on the seat 7), and when the content of the autonomous driving operation is leftward steering, the headrest 7h is rotated in the negative direction from the reference position (that is, the left direction as viewed from the occupant sitting on the seat 7). This enables the occupant to recognize whether the host vehicle 1 is going to be steered rightward or leftward.

Both the target for rotating the seat 7 and the rotation angle θc at this time also correspond to the “target position”. The electric actuator 7mH and the electric actuator 7mG of the present modification also correspond to the “driving portion”.

Further, in the third modification described above, the mode in which the headrest 7h is rotated in the front-back direction or the right-left direction in accordance with the magnitude of the acceleration rate or the steering amount can be variously modified as in the present embodiment described above.

That is, as in the case described above with reference to FIG. 9 and

FIG. 10, the magnitude of the acceleration rate or the steering amount may be proportional to the angle at which the headrest 7h is rotated. Alternatively, as in the case described above with reference to FIG. 11A, when the absolute value of the acceleration rate or the steering amount is smaller than the predetermined threshold, the amount of change in the angle with respect to the amount of change in the acceleration rate or the steering amount may be made smaller than that when the absolute value is larger than the predetermined threshold. Alternatively, as in the case described above with reference to FIG. 11B and FIG. 11C, the angle obtained by rotating the headrest 7h may be varied stepwise with respect to the acceleration rate or the steering amount.

Further, as in the case described above with reference to FIG. 12, the driver may be notified that acceleration or deceleration is going to be performed by vibration of the headrest 7h forward and backward or rightward and leftward. At this time, the amplitude A for vibrating the headrest 7h forward and backward or rightward and leftward, the frequency f for vibration, and the duration T of vibration may be changed in accordance with the acceleration rate or the steering amount.

### C-4. Fourth Modification

Further, notice of the content of the autonomous driving operation can be given by providing a part of the floor surface in front of the seat 7 so as to be movable and moving the movable floor surface (hereinafter referred to as moving floor surface).

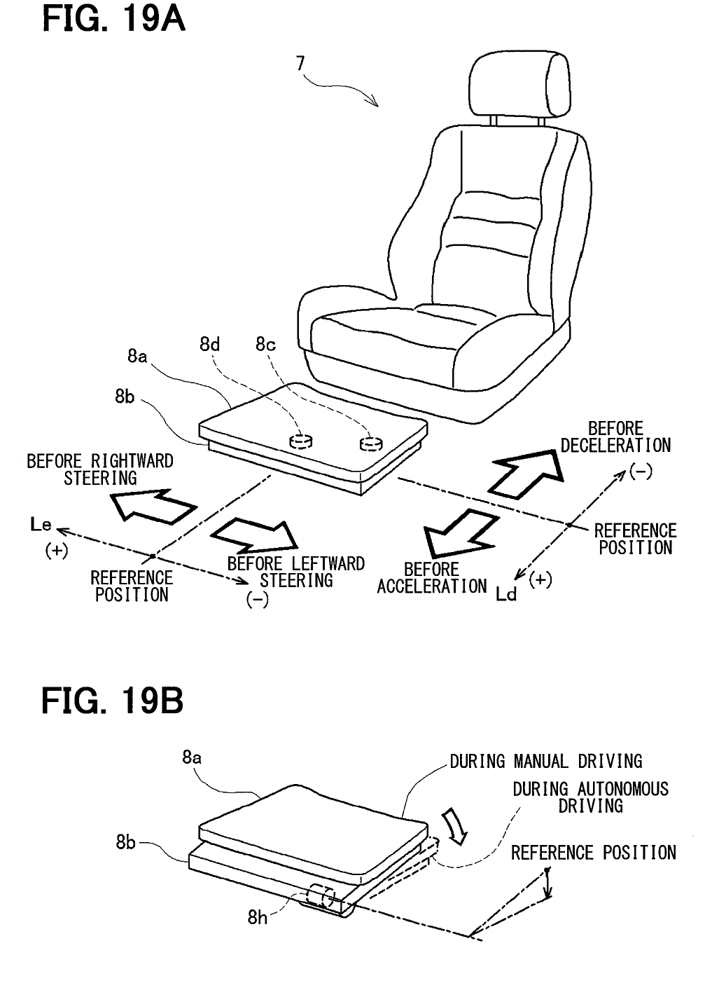

FIG. 19A and FIG. 19B illustrate a fourth modification in which a moving floor surface 8a is moved in accordance with the content of the autonomous driving operation.

As illustrated in FIG. 19A, the moving floor surface 8a of the fourth modification is attached to a base portion 8b installed on the floor surface of the host vehicle 1 so as to be slidable in the front-back direction and the right-left direction. The moving floor surface 8a can be slid in the front-back direction by using an electric actuator 8c. The moving floor surface 8a can be slid in the right-left direction by using an electric actuator 8d.

The electric actuator 8c and the electric actuator 8d of the present modification also correspond to the “driving portion”.

In such a fourth modification, when the content of the autonomous driving operation is acceleration, the moving floor surface 8a is moved in the forward direction from the reference position, and when the content of the autonomous driving operation is deceleration, the moving floor surface 8a is moved in the backward direction from the reference position. This enables the occupant to recognize whether the host vehicle 1 is going to be accelerated or decelerated.

A target position Ld for moving the moving floor surface 8a at this time also corresponds to the “target position”.

When the content of the autonomous driving operation is rightward steering, the moving floor surface 8a is moved in the right direction from the reference position as viewed from the occupant sitting on the seat 7. When the content of the autonomous driving operation is leftward steering, the moving floor surface 8a is moved in the left direction from the reference position as viewed from the occupant sitting on the seat 7. This enables the occupant to recognize whether the host vehicle 1 is going to be steered rightward or leftward.

The target position Le for moving the moving floor surface 8a at this time also corresponds to the “target position”.

Further, in the fourth modification described above, the mode in which the moving floor surface 8a is moved in the front-back direction or the right-left direction in accordance with the magnitude of the acceleration rate or the steering amount can be variously modified as in the present embodiment described above.

That is, as in the case described above with reference to FIG. 9 and FIG. 10, the magnitude of the acceleration rate or the steering amount may be proportional to the movement amount of the moving floor surface 8a. Alternatively, as in the case described above with reference to FIG. 11A, when the absolute value of the acceleration rate or the steering amount is smaller than the predetermined threshold, the amount of change in the moving amount with respect to the amount of change in the acceleration rate or the steering amount may be made smaller than that when the absolute value is larger than the predetermined threshold. Alternatively, as in the case described above with reference to FIG. 11B and FIG. 11C, the movement amount may be varied stepwise with respect to the acceleration rate or the steering amount.

Further, as in the case described above with reference to FIG. 12, the driver may be notified that acceleration or deceleration is going to be performed by vibration of the moving floor surface 8a forward and backward or rightward and leftward. At this time, the amplitude A for vibrating the moving floor surface 8a forward and backward or rightward and leftward, the frequency f for vibration, and the duration T of the vibration may be changed in accordance with the acceleration rate or the steering amount.

As in the fourth modification, in the mode of moving the moving floor surface 8a, the legs of the occupant sitting on the seat 7 are moved. Thus, when the occupant is sitting on the seat 7 on the driver's seat side, the knees of the occupant may interfere with the steering wheel 6 when the moving floor surface 8a is moved.

Therefore, during the autonomous driving, the position of the moving floor surface 8a may be made lower than in the case of manual operation. For example, prior to the start of the autonomous driving, the moving floor surface 8a may be moved together with the base portion 8b to a position lower than that during the manual driving, and the moving floor surface 8a may be moved in that state, to thereby give notice of the content of the autonomous driving to the occupant. The moving floor surface 8a may be moved to a lower position without moving the base portion 8b.

Alternatively, as illustrated in FIG. 19B, the front side of the base portion 8b (the back side as viewed from the occupant sitting on the seat 7) may be pivotally supported, and an electric actuator 8h may then be driven, to thereby rotate the base portion 8b so that the back side (the front side viewed from the occupant sitting on the seat 7) becomes lower with the front side of the base portion 8b at the center. Then, at the time of returning from the autonomous driving to the manual driving, the base portion 8b may be returned to the original position by driving the electric actuator 8h again.

In this manner, it is possible to move the moving floor surface 8a to the lower position during the autonomous driving and to return the moving floor surface 8a to the original position when the autonomous driving is terminated.

Further, in the fourth modification described above, the movement mode of the moving floor surface 8a has been described as a mode in which the moving floor surface 8a is translated forward, backward, leftward and rightward. However, the mode of moving the moving floor surface 8a is not necessarily translation, and various modes can be adopted as long as the driver can recognize the movement of the moving floor surface 8a.

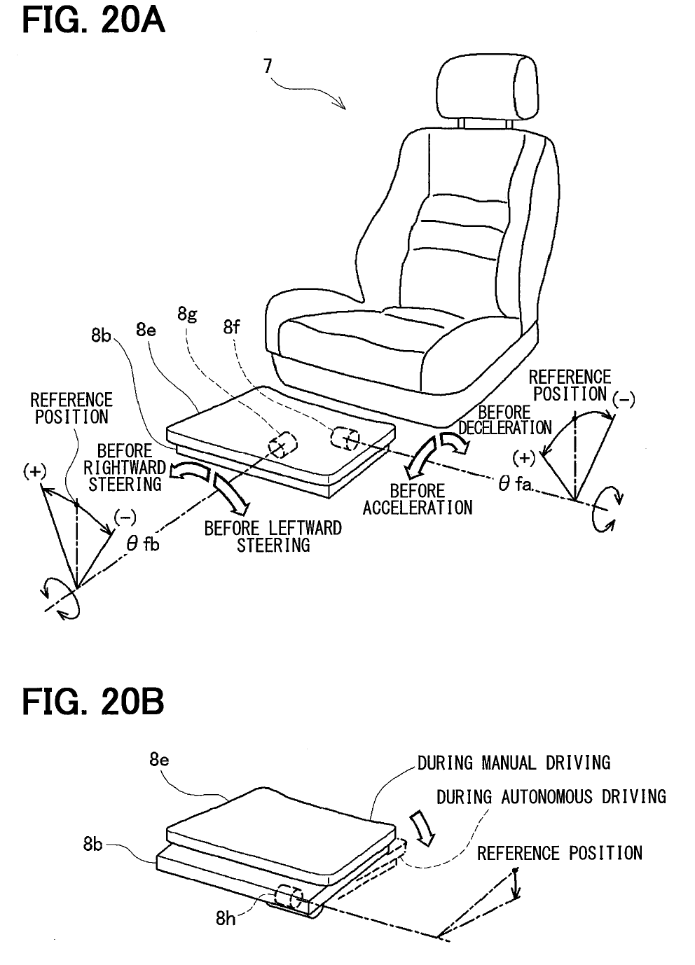

For example, as illustrated in FIG. 20A and FIG. 20B, there may be provided a moving floor surface 8e attached to the base portion 8b so as to be inclinable in the front-back direction and the right-left direction, an electric actuator 8f for inclining the moving floor surface 8e in the front-back direction, and an electric actuator 8g for inclining the moving floor surface 8e in the right-left direction.

The electric actuator 8f and the electric actuator 8g of the present modification also correspond to the “driving portion”.

Then, when the content of the autonomous driving operation is acceleration, as illustrated in FIG. 20A and FIG. 20B, the moving floor surface 8e is rotated in the positive direction from the reference position (that is, the direction in which the back side as viewed from the occupant sitting on the seat 7 becomes lower), and when the content of the autonomous driving operation is deceleration, the moving floor surface 8e is rotated in the negative direction from the reference position (that is, the direction in which the back side as viewed from the occupant sitting on the seat 7 becomes higher). This enables the occupant to recognize whether the host vehicle 1 is going to be accelerated or decelerated.

An angle θfa for rotating the moving floor surface 8e at this time also corresponds to the “target position”.

When the content of the autonomous driving operation is rightward steering, the moving floor surface 8e is rotated in the positive direction from the reference position (that is, the right direction as viewed from the occupant sitting on the seat 7), and when the content of the autonomous driving operation is leftward steering, the moving floor surface 8e is rotated in the negative direction from the reference position (that is, the left direction as viewed from the occupant sitting on the seat 7). This enables the occupant to recognize whether the host vehicle 1 is going to be steered rightward or leftward.

An angle θfb for rotating the moving floor surface 8e at this time also corresponds to the “target position”.

Further, in the fourth modification described above, the mode in which the moving floor surfaces 8a, 8e are moved (or rotated) in accordance with the magnitude of the acceleration rate or the steering amount can be variously modified as in the present embodiment described above.

That is, as in the case described above with reference to FIG. 9 and FIG. 10, the magnitude of the acceleration rate or the steering amount may be proportional to the movement amount of the moving floor surface 8a (or the angles θfa, ″fb of the moving floor surface 8e). Alternatively, as in the case described above with reference to FIG. 11A, when the absolute value of the acceleration rate or the steering amount is smaller than the predetermined threshold, the amount of change in the moving amount (or the angles θfa, θfb) with respect to the amount of change in the acceleration rate or the steering amount may be made smaller than that when the absolute value is larger than the predetermined threshold. Alternatively, as in the case described above with reference to FIG. 11B and FIG. 11C, the movement amount (or the angles θfa, θfb) may be varied stepwise with respect to the acceleration rate or the steering amount.

Further, as in the case described above with reference to FIG. 12, the driver may be notified that acceleration or deceleration is going to be performed by vibration of the moving floor surface 8e forward and backward or rightward and leftward. At this time, the amplitude A for vibrating the moving floor surface 8e forward and backward or rightward and leftward, the frequency f for vibration, and the duration T of the vibration may be changed in accordance with the acceleration rate or the steering amount.

In addition, even in the mode of inclining the moving floor surface 8e, since the legs of the occupant sitting on the seat 7 are moved similarly to the mode of moving the moving floor surface 8a described above, the knees of the occupant may interfere with the steering wheel 6 when the moving floor surface 8e is inclined.

Therefore, during the autonomous driving, the position of the moving floor surface 8e may be made lower than in the case of manual driving. For example, the moving floor surface 8e may be moved together with the base portion 8b to a position lower than that during the manual driving. The moving floor surface 8e may be moved to a lower position without moving the base portion 8b.

Alternatively, as illustrated in FIG. 20B, the front side of the base portion 8b (the back side as viewed from the occupant sitting on the seat 7) may be pivotally supported, and an electric actuator 8h may then be driven, to thereby rotate the base portion 8b so that the back side (the front side viewed from the occupant sitting on the seat 7) becomes lower with the front side of the base portion 8b at the center.

In this manner, it is possible to move the moving floor surface 8e to the lower position during the autonomous driving and to return the moving floor surface 8e to the original position when the autonomous driving is terminated.

### C-5. Fifth Modification

Alternatively, an armrest 9 may be movably provided and moved so as to give notice of the content of the autonomous driving operation.

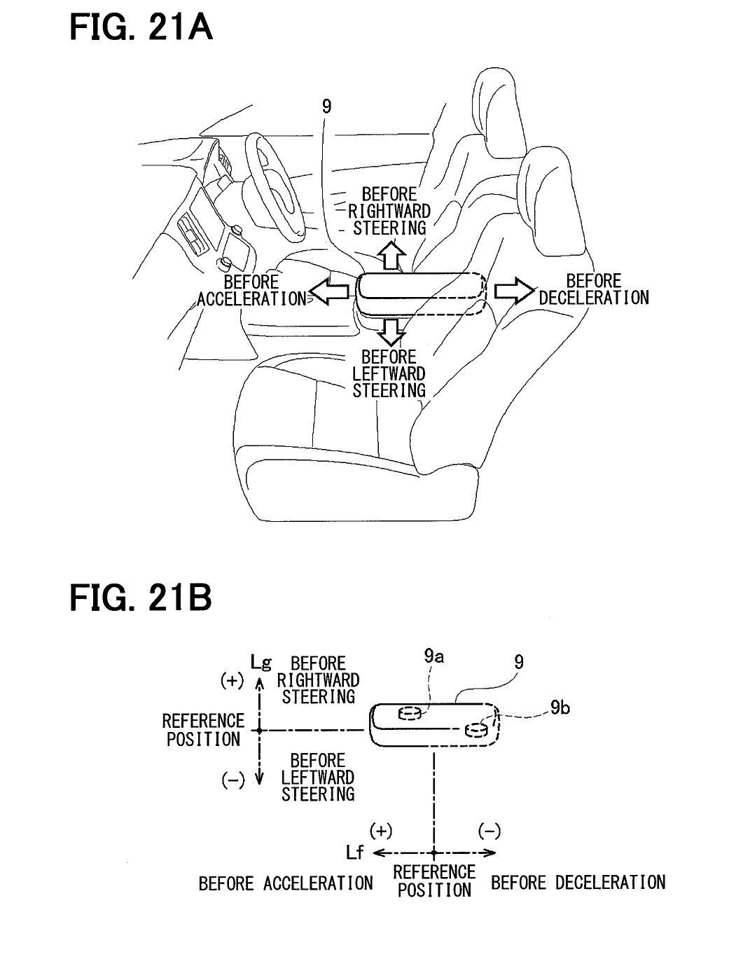

FIG. 21A and FIG. 21B illustrate a fifth modification in which the armrest 9 is moved in accordance with the content of the autonomous driving operation.

As shown in FIG. 21A, the armrest 9 of the fifth modification is provided so as to be slidable in the front-back direction and the right-left direction. Further, as shown in FIG. 21 B, an electric actuator 9a for sliding the armrest 9 in the front-back direction and an electric actuator 9b for sliding the armrest 9 in the right-left direction are mounted inside the armrest 9.

The electric actuator 9a and the electric actuator 9b of the present modification also correspond to the “driving portion”.

In such a fifth modification, when the content of the autonomous driving operation is acceleration, the armrest 9 is moved in the forward direction from the reference position, and when the content of the autonomous driving operation is deceleration, the armrest 9 is moved in the backward direction from the reference position. This enables the occupant to recognize whether the host vehicle 1 is going to be accelerated or decelerated.

A target position Lf to which the armrest 9 is moved at this time also corresponds to the “target position”.

When the content of the autonomous driving operation is rightward steering, the armrest 9 is moved in the right direction from the reference position as viewed from the occupant sitting on the seat 7, and when the content of the autonomous driving operation is leftward steering, the armrest 9 is moved in the left direction from the reference position as viewed from the occupant sitting on the seat 7. This enables the occupant to recognize whether the host vehicle 1 is going to be steered rightward or leftward.

A target position Lg to which the armrest 9 is moved at this time also corresponds to the “target position”.

Further, the mode of moving the armrest 9 is not limited to the mode of translating the armrest 9 as illustrated in FIG. 21A and FIG. 21B, but the armrest 9 may be inclined in the front-back direction and the right-left direction.

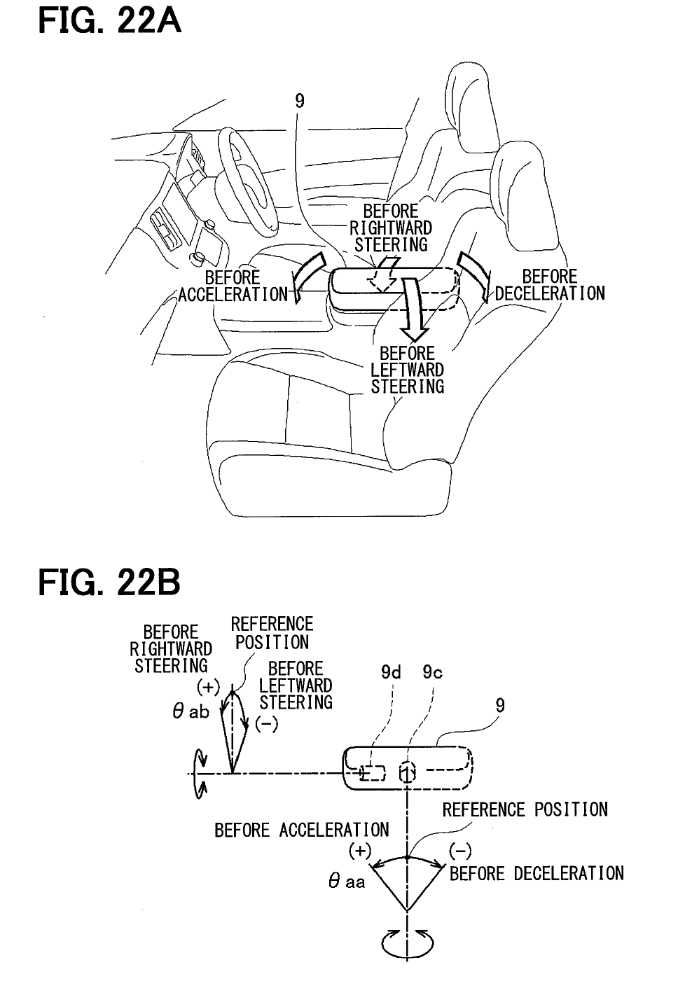

For example, as illustrated in FIG. 22A, the armrest 9 may be provided so as to be inclinable in the front-back direction and the right-left direction, and as shown in FIG. 22B, an electric actuator 9c for inclining the armrest 9 in the front-back direction and an electric actuator 9d for inclining the armrest 9 in the right-left direction may be provided.

The electric actuator 9c and the electric actuator 9d of the present modification also correspond to the “driving portion”.

Then, when the content of the autonomous driving operation is acceleration, as illustrated in FIG. 22A and FIG. 22B, the armrest 9 is rotated in the positive direction from the reference position (that is, the direction in which the front side becomes lower), and when the content of the autonomous driving operation is deceleration, the armrest 9 is rotated in the negative direction from the reference position (that is, the direction in which the back side becomes higher). This enables the occupant to recognize whether the host vehicle 1 is going to be accelerated or decelerated.

An angle θaa at which the armrest 9 is rotated at this time also corresponds to the “target position”.

When the content of the autonomous driving operation is rightward steering, the armrest 9 is rotated in the positive direction from the reference position (that is, the right direction as viewed from the occupant sitting on the seat 7), and when the content of the autonomous driving operation is leftward steering, the armrest 9 is rotated in the negative direction from the reference position (that is, the left direction as viewed from the occupant sitting on the seat 7). This enables the occupant to recognize whether the host vehicle 1 is going to be steered rightward or leftward.

An angle θab at which the armrest 9 is rotated at this time also corresponds to the “target position”.

Further, in the fifth modification described above, the mode in which the armrest 9 is moved in the front-back direction or the right-left direction, or the mode in which the armrest 9 is inclined, in accordance with the magnitude of the acceleration rate or the steering amount can be variously modified as in the present embodiment described above.

That is, as in the case described above with reference to FIG. 9 and FIG. 10, the magnitude of the acceleration rate or the steering amount may be proportional to the movement amount of the armrest 9 (or the angles θaa, θab). Alternatively, as in the case described above with reference to FIG. 11A, when the absolute value of the acceleration rate or the steering amount is smaller than the predetermined threshold, the amount of change in the moving amount (or the angles θaa, θab) with respect to the amount of change in the acceleration rate or the steering amount may be made smaller than that when the absolute value is larger than the predetermined threshold. Alternatively, as in the case described above with reference to FIG. 11B and FIG. 11C, the movement amount (or the angles θaa, θab) may be varied stepwise with respect to the acceleration rate or the steering amount.

Further, as in the case described above with reference to FIG. 12, the driver may be notified that acceleration or deceleration is going to be performed by vibration of the armrest 9 forward and backward or rightward and leftward. At this time, the amplitude A for vibrating the armrest 9 forward and backward or rightward and leftward, the frequency f for vibration, and the duration T of vibration may be changed in accordance with the acceleration rate or the steering amount.

In addition, when a situation which is difficult for the autonomous driving control apparatus 100 to deal with occurs during the autonomous driving, the driver needs to drive the vehicle instead. In such a case, at least one of the backrest portion 7b and the lumbar support portions 7R, 7L of the seat 7, the entire seat 7, the headrest 7h, the moving floor surfaces 8a, 8e, and the armrest 9 may be vibrated to request override to the driver, (that is, the autonomous driving state is switched to the manual driving state by the driver performing the driving operation to intervene in the driving during the autonomous driving).

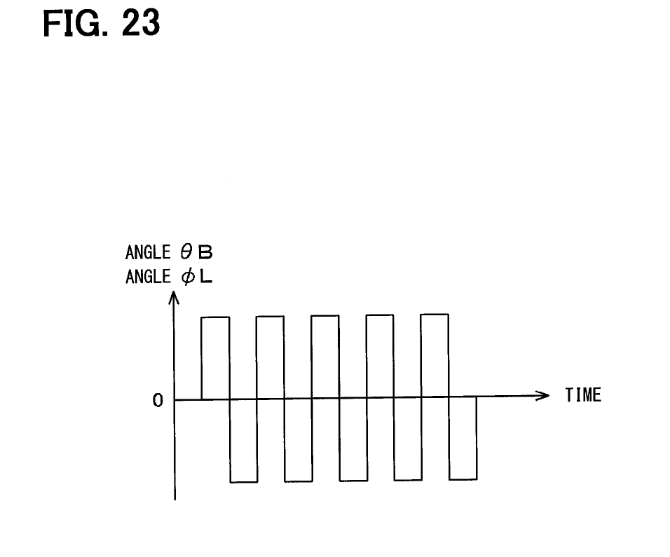

For example, as shown in FIG. 23, the angle OB of the backrest portion 7b of the seat 7 is vibrated in a certain period, or the angle ϕL of the lumbar support portions 7R, 7L is vibrated in a certain period. The entire seat 7 may be moved forward and backward in a certain period, the headrest 7h, the moving floor surface 8e, or the armrest 9 may be rotated forward and backward or rightward and leftward in a certain period, or the moving floor surface 8a or the armrest 9 may be vibrated forward and backward or rightward and leftward. Since such a movement is apparently different from that of the notice of the content of normal autonomous driving, the driver can easily recognize that the override is requested.

While various embodiments, configurations, and aspects of a detection apparatus according to the present disclosure have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects of the present disclosure.

1. An autonomous driving control apparatus that controls driving operation of a host vehicle based on a surrounding situation of the host vehicle to achieve autonomous driving, the autonomous driving control apparatus comprising:
a driving operation decision portion that decides a content of the driving operation of the host vehicle based on the surrounding situation of the host vehicle;
a driving operation control portion that controls the driving operation of the host vehicle in accordance with the decided content of the driving operation; and
a driving information output portion that drives a driving portion provided in a seat of the host vehicle, to output the decided content of the driving operation as driving information.

2. The autonomous driving control apparatus according to claim 1, wherein:
the driving portion is provided by a driving portion that drives a backrest portion of the seat.

3. The autonomous driving control apparatus according to claim 1, wherein:
the driving portion is provided by a driving portion that drives a lumbar support portion of the seat.

4. The autonomous driving control apparatus according to claim 1, wherein:
the driving portion is provided by a driving portion that drives a headrest of the seat.

5. An autonomous driving control apparatus that controls driving operation of a host vehicle based on a surrounding situation of the host vehicle to achieve autonomous driving, the autonomous driving control apparatus comprising:
a driving operation decision portion that decides a content of the driving operation of the host vehicle based on the surrounding situation of the host vehicle;
a driving operation control portion that controls the driving operation of the host vehicle in accordance with the decided content of the driving operation; and
a driving information output portion that drives a driving portion of a moving floor surface provided in a movable mode in front of a seat of the host vehicle and moves the moving floor surface, to output the decided content of the driving operation as driving information.

6. The autonomous driving control apparatus according to claim 5, wherein:
regarding the moving floor surface,
the driving information output portion drives the driving portion that vertically moves the moving floor surface, prior to outputting the driving information by moving the moving floor surface, to move the moving floor surface to a position lower than the moving floor surface during manual driving.

7. An autonomous driving control apparatus that controls driving operation of a host vehicle based on a surrounding situation of the host vehicle to achieve autonomous driving, the autonomous driving control apparatus comprising:
a driving operation decision portion that decides a content of the driving operation of the host vehicle based on the surrounding situation of the host vehicle;
a driving operation control portion that controls the driving operation of the host vehicle in accordance with the decided content of the driving operation; and
a driving information output portion that drives a driving portion of an armrest provided in a movable mode lateral to a seat of the host vehicle and moves the armrest, to output the decided content of the driving operation as driving information.

8. The autonomous driving control apparatus according to claim 1, comprising:
a collision time calculation portion that acquires a distance to a forward object being a vehicle or an obstacle existing in front of the host vehicle and a relative speed between the forward object and the host vehicle, to calculate collision time for the forward object,
wherein:
the driving operation decision portion compares a predetermined first threshold time with the collision time to decide execution timing of the driving operation; and
the driving information output portion outputs the driving information at timing decided by comparing a predetermined second threshold time with the collision time, the predetermined second threshold time being larger than the first threshold time.

9. The autonomous driving control apparatus according to claim 1, comprising:
a host vehicle position acquisition portion that acquires a host vehicle position at which the host vehicle exists; and
a map information acquisition portion that acquires map information of an area including the host vehicle position,
wherein:
the driving operation decision portion decides the content of the driving operation based on the host vehicle position and the map information, and decides execution timing of the driving operation by deciding the position of the host vehicle on the map information on which the driving operation is performed; and
the driving information output portion outputs the driving information at a position located a predetermined distance before the position of the host vehicle on the map information on which the driving operation is performed.

10. The autonomous driving control apparatus according to claim 1, further comprising:
a surrounding environment acquisition portion that acquires a surrounding environment of the host vehicle,
wherein:
the driving operation decision portion decides the content of the driving operation and execution timing of the driving operation based on the surrounding environment.

11. The autonomous driving control apparatus according to claim 10, wherein:
the surrounding environment acquisition portion analyzes a captured image obtained by an in-vehicle camera mounted on the host vehicle to acquire a road shape in front of the host vehicle as the surrounding environment; and
the driving operation decision portion decides the content of the driving operation and the execution timing of the driving operation based on the road shape.

12. The autonomous driving control apparatus according to claim 10, wherein:
the surrounding environment acquisition portion acquires a distance to an intersection existing in front of the host vehicle as the surrounding environment; and
the driving operation decision portion decides the content of the driving operation and the execution timing of the driving operation based on the distance to the intersection.

13. The autonomous driving control apparatus according to claim 10, wherein:
the surrounding environment acquisition portion acquires a distance to a tunnel entrance or a tunnel exit existing in front of the host vehicle as the surrounding environment; and
the driving operation decision portion decides the content of the driving operation and the execution timing of the driving operation based on a distance to the tunnel entrance or the tunnel exit.

14. The autonomous driving control apparatus according to claim 10, wherein:
the surrounding environment acquisition portion acquires a distance to an ending point of an ascending slope existing in front of the host vehicle as the surrounding environment; and
the driving operation decision portion decides the content of the driving operation and the execution timing of the driving operation based on the distance to the ending point of the ascending slope.

15. The autonomous driving control apparatus according to claim 10, wherein:
the surrounding environment acquisition portion analyzes a captured image obtained by the in-vehicle camera mounted on the host vehicle, to acquire a degree of visibility forward from the host vehicle as the surrounding environment; and
the driving operation decision portion decides the content of the driving operation and the execution timing of the driving operation based on the degree of visibility.

16. The autonomous driving control apparatus according to claim 2, wherein:
the driving information output portion outputs the driving information on acceleration or deceleration of the host vehicle.

17. The autonomous driving control apparatus according to claim 16, wherein:
the driving information output portion varies a target position of an object to be driven by the driving portion in accordance with a degree of acceleration or deceleration of the host vehicle, to output the driving information.

18. The autonomous driving control apparatus according to claim 17, wherein:
in a range in which the degree of acceleration or deceleration of the host vehicle is smaller than a predetermined value, the driving information output portion varies the target position such that an amount of change in the target position with respect to the degree of acceleration or deceleration becomes a smaller value than a value in a range in which the degree of acceleration or deceleration is larger than the predetermined value.

19. The autonomous driving control apparatus according to claim 17, wherein:
in a range in which the degree of acceleration or deceleration of the host vehicle is smaller than a predetermined value, the driving information output portion varies the target position such that an amount of change in the target position with respect to the degree of acceleration or deceleration becomes a larger value than a value in a range in which the degree of acceleration or deceleration is larger than the predetermined value.

20. The autonomous driving control apparatus according to claim 17, wherein:
the driving information output portion varies the target position in accordance with a magnitude relationship between the degree of acceleration or deceleration of the host vehicle and a predetermined threshold, to output the driving information.

21. The autonomous driving control apparatus according to claim 17, wherein:
the driving information output portion varies the target position in accordance with a magnitude relationship between the degree of acceleration or deceleration of the host vehicle and each of a plurality of thresholds, to output the driving information.

22. The autonomous driving control apparatus according to claim 16, wherein:
the driving information output portion causes vibration of an object to be driven by the driving portion in a mode in accordance with a degree of acceleration or deceleration of the host vehicle, to output the driving information.

23. The autonomous driving control apparatus according to claim 2, wherein:
the driving information output portion outputs the driving information on a vehicle speed of the host vehicle.

24. The autonomous driving control apparatus according to claim 23, wherein:
the driving information output portion varies a target position of an object to be driven by the driving portion in accordance with a target vehicle speed of the host vehicle, to output the driving information.

25. The autonomous driving control apparatus according to claim 23, wherein:
in a range in which a target vehicle speed of the host vehicle is smaller than a predetermined value, the driving information output portion varies the target position such that an amount of change in the target position with respect to the target vehicle speed becomes a smaller value than a value in a range in which the target vehicle speed of the host vehicle is larger than the predetermined value.

26. The autonomous driving control apparatus according to claim 23, wherein:
the driving information output portion varies the target position in accordance with a magnitude relationship between a target vehicle speed of the host vehicle and a predetermined threshold, to output the driving information.

27. The autonomous driving control apparatus according to claim 26, wherein:
the driving information output portion varies the target position in accordance with a magnitude relationship between the target vehicle speed of the host vehicle and each of a plurality of thresholds, to output the driving information.

28. The autonomous driving control apparatus according to claim 23, wherein:
the driving information output portion causes vibration of an object to be driven by the driving portion in a mode in accordance with a degree of acceleration or deceleration of the host vehicle, to output the driving information.

29. The autonomous driving control apparatus according to claim 3, wherein:
the driving information output portion outputs steering information on steering of the host vehicle as the driving information.

30. The autonomous driving control apparatus according to claim 29, wherein:
the driving information output portion varies a target position of an object to be driven by the driving portion in accordance with a magnitude of the steering information, to output the driving information.

31. The autonomous driving control apparatus according to claim 30, wherein:
in a range in which the magnitude of the steering information is smaller than a predetermined value, the driving information output portion varies the target position such that an amount of change in the target position with respect to the magnitude of the steering information becomes a smaller value than a value in a range in which the magnitude of the steering information is larger than the predetermined value.

32. The autonomous driving control apparatus according to claim 30, wherein:
the driving information output portion varies the target position in accordance with a magnitude relationship between the magnitude of the steering information and a predetermined threshold, to output the driving information.

33. The autonomous driving control apparatus according to claim 32, wherein:
the driving information output portion varies the target position in accordance with a magnitude relationship between the magnitude of the steering information and each of a plurality of threshold angles, to output the driving information.

34. The autonomous driving control apparatus according to claim 29, wherein:
the driving information output portion causes vibration of an object to be driven by the driving portion in a mode in accordance with a magnitude of the steering information, to output the driving information.

35. The autonomous driving control apparatus according to claim 1, wherein:
the driving operation decision portion decides whether a warning is required in addition to the content of the driving operation; and
the driving information output portion causes vibration of an object to be driven by the driving portion when it is decided that the warning is required, to perform a warning operation.

36. A driving information output apparatus that is mounted on a host vehicle capable of autonomous driving based on a surrounding situation and outputs driving information on a content of the driving operation during the autonomous driving to an occupant of the host vehicle, the driving information output apparatus comprising:
a driving information acquisition portion that acquires the driving information from an autonomous driving control portion for controlling the driving operation of the host vehicle during the autonomous driving; and
a driving information output portion that drives a driving portion provided in a seat of the host vehicle, to output the decided content of the driving operation as driving information.

37. An autonomous driving control method for controlling driving operation of a host vehicle based on a surrounding situation of the host vehicle to achieve autonomous driving, the method comprising:
deciding a content of the driving operation of the host vehicle based on the surrounding situation of the host vehicle;
driving a driving portion provided in a seat of the host vehicle, to output the decided content of the driving operation as driving information; and
controlling the driving operation of the host vehicle in accordance with the decided content of the driving operation.

38. A driving information output method that is applied to a host vehicle capable of autonomous driving based on a surrounding situation, to output driving information on a content of driving operation during the autonomous driving to an occupant of the host vehicle, the method comprising:
acquiring the driving information; and
driving a driving portion provided in a seat of the host vehicle, to output the decided content of the driving operation as driving information.

39. An autonomous driving control method for controlling driving operation of a host vehicle based on a surrounding situation of the host vehicle to achieve autonomous driving, the method comprising:
deciding a content of the driving operation of the host vehicle based on the surrounding situation of the host vehicle;
driving a driving portion of a moving floor surface provided in a movable mode in front of a seat of the host vehicle and moving the moving floor surface, to output the decided content of the driving operation as driving information; and
controlling the driving operation of the host vehicle in accordance with the decided content of the driving operation.

40. A driving information output method that is applied to a host vehicle capable of autonomous driving based on a surrounding situation, to output driving information on a content of driving operation during the autonomous driving to an occupant of the host vehicle, the method comprising:
acquiring the driving information; and
driving a driving portion of a moving floor surface provided in a movable mode in front of a seat of the host vehicle and moving the moving floor surface, to output the decided content of the driving operation as driving information.

41. An autonomous driving control method for controlling driving operation of a host vehicle based on a surrounding situation of the host vehicle to achieve autonomous driving, the method comprising:
deciding a content of the driving operation of the host vehicle based on the surrounding situation of the host vehicle;
driving a driving portion of an armrest provided in a movable mode lateral to a seat of the host vehicle and moving the moving floor surface, to output the decided content of the driving operation as driving information; and
controlling the driving operation of the host vehicle in accordance with the decided content of the driving operation.

42. A driving information output method that is applied to a host vehicle capable of autonomous driving based on a surrounding situation, to output driving information on a content of driving operation during autonomous driving to an occupant of the host vehicle, the method comprising:
acquiring the driving information; and
driving a driving portion of an armrest provided in a movable mode lateral to a seat of the host vehicle and moving the moving floor surface, to output the decided content of the driving operation as driving information.
